(19) United States
(12) Patent Application Publication
(10) Pub. No.: US 2022/0094540 A1
(43) Pub. Date: Mar. 24, 2022

(54) ON-VEHICLE COMMUNICATION SYSTEM, ON-VEHICLE COMMUNICATION CONTROL DEVICE, ON-VEHICLE COMMUNICATION DEVICE, COMMUNICATION CONTROL METHOD AND COMMUNICATION METHOD

(71) Applicants: National University Corporation Tokai National Higher Education and Research System, Nagoya-shi, Aichi (JP); AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Ryo KURACHI, Nagoya-shi, Aichi (JP); Hiroaki Takada, Nagoya-shi, Aichi (JP); Naoki Adachi, Yokkaichi-shi, Mie (JP); Hiroshi Ueda, Yokkaichi-shi, Mie (JP)

(21) Appl. No.: 17/420,862

(22) PCT Filed: Dec. 20, 2019
(86) PCT No.: PCT/JP2019/050009

§ 371 Date: Jul. 6, 2021

(30) Foreign Application Priority Data
Jan. 9, 2019 (JP) 2019-002124

(51) Int. Cl. H04L 9/14; H04L 9/32

(52) U.S. Cl. CPC H04L 9/14; H04L 2209/84; H04L 9/3242

(57) ABSTRACT

In the on-vehicle communication system according to the present embodiment, a plurality of on-vehicle communication devices are classified by a plurality of security levels, and a common key is specified for each of the security levels. Each of the on-vehicle communication devices stores a common key according to a security level of itself, adds an authentication code generated by using the common key to a message to be transmitted and determines whether or not an authentication code added to a received message is authorized by using the common key. The on-vehicle communication control device stores common keys of respective security levels, determines whether or not a authentication code added to a received message is authorized by using the corresponding common key and, if determining that the authentication code is not authorized, makes a report to the on-vehicle communication device that does not store the common key used for this determination.

### CROSS-REFERENCE TO RELATED APPLICATIONS

This application is the U.S. national stage of PCT/JP2019/050009 filed on Dec. 20, 2019, which claims priority of Japanese Patent Application No. JP 2019-002124 filed on Jan. 9, 2019, the contents of which are incorporated herein.

### TECHNICAL FIELD

The present disclosure relates to an on-vehicle communication system that allows communication between multiple devices mounted on a vehicle, an on-vehicle communication control device, an on-vehicle communication device, a communication control method and a communication method.

### BACKGROUND

An automatic driving or driving assist technique for a vehicle has recently been searched and developed, which pursues high functionality of a vehicle. As a vehicle increases in functionality, hardware and software in devices such as an electronic control unit (ECU) mounted on the vehicle have been sophisticated in functionality and complicated. Meanwhile, entry of an unauthorized device or software to an on-vehicle system may cause an attack such as an abuse of a vehicle, for example. In order to prevent an unauthorized attack on a vehicle, various measures such as encryption of communication, for example, have been considered.

Japanese Patent Application Laid-Open No. 2016-21623 discloses a communication system in which a plurality of ECUs and a monitoring device are connected to a common controller area network (CAN) bus, each of the ECUs outputs a transmission frame to which authentication information is added to the CAN bus while the monitoring device determines right or wrong of authentication information contained in the frame that is output to the CAN bus and performs processing of causing the ECUs to discard the frame for which the authentication information is wrong.

As described in the communication system disclosed in Japanese Patent Application Laid-Open No. 2016-21623, a method of transmitting a message to which an authentication code or the like has been added by each of the devices connected to a common communication line is effective for improvement in security performance. As the devices mounted on a vehicle are increased in number and sophisticated in functionality, it is expected that a required security level may vary depending on the devices. Until now, a situation where a plurality of devices to which different security levels are respectively set coexist in a vehicle has not been taken into consideration.

The present disclosure is made in view of such circumstances, and an object thereof is to provide an on-vehicle communication system that allows coexistence of multiple devices to which different security levels are set, an on-vehicle communication control device, an on-vehicle communication device, a communication control method and a communication method.

### SUMMARY

An on-vehicle communication system according one aspect is an on-vehicle communication system comprising a plurality of on-vehicle communication devices connected to a common communication line and an on-vehicle communication control device connected to the common communication line and performing control related to communication between the plurality of on-vehicle communication devices. The plurality of on-vehicle communication devices are classified by a plurality of security levels, and a common key is specified for each of the security levels. An on-vehicle communication device of the on-vehicle communication devices includes a first storage unit that stores a common key according to a security level of the on-vehicle communication device, a first authentication code generation unit that generates an authentication code to be added to a message to be transmitted by using a common key stored in the first storage unit, and a first authentication code determination unit that determines whether or not an authentication code added to a received message is authorized by using a common key stored in the first storage unit. The on-vehicle communication control device includes a second storage unit that stores a common key for each of the security levels, a second authentication code determination unit that determines whether or not an authentication code added to a received message is authorized by using a corresponding common key stored in the second storage unit, and a second report unit that, if the second authentication code determination unit determines that an authentication code added to a received message is not authorized, makes a report to another one of the on-vehicle communication devices that does not store a common key used for the determination by the second authentication code determination unit.

It is noted that the present application can be not only embodied as an on-vehicle communication control device or an on-vehicle communication device having a characteristic processing unit but also embodied as communication control method or a communication method executing such characteristic processing in steps and as a computer program causing the computer to execute such steps. In addition, the present application can be embodied as a semiconductor integrated circuit executing a part or all of the on-vehicle communication control device or the on-vehicle communication device or as another device or system including the on-vehicle communication control device and the on-vehicle communication device.

### Advantageous Effects

According to the above-description, it is possible to allow coexistence of multiple devices to which different security levels are respectively set.

### DESCRIPTION OF THE DRAWINGS

FIG. 1 is a schematic view illustrating the outline of an on-vehicle communication system according to a present embodiment.

FIG. 2 is a schematic view illustrating the outline of the on-vehicle communication system according to the present embodiment.

FIG. 3 is a schematic view illustrating one example of transmission and reception of messages performed between a DC and ECUs.

FIG. 4 is a schematic view illustrating one example of making a report from the DC to the ECUs.

FIG. 5 is a block diagram illustrating the configuration of the DC according to the present embodiment.

FIG. 6 is a schematic view illustrating one example of information on encryption keys stored in a table.

FIG. 7 is a block diagram illustrating the configuration of the ECU according to the present embodiment.

FIG. 8 is a schematic view illustrating a transmission timing of a report message by the DC.

FIG. 9 is a flowchart showing the procedure of message reception processing performed by the ECU according to the present embodiment.

FIG. 10 is a flowchart showing the procedure of keep alive signal transmission processing performed by the ECU according to the present embodiment.

FIG. 11 is a flowchart showing the procedure of report message transmission processing performed by the DC according to the present embodiment.

FIG. 12 is a flowchart showing the procedure of report message transmission processing performed by the DC according to the present embodiment.

FIG. 13 is a schematic view illustrating one example of transmission and reception of messages performed between a DC and ECUs according to Embodiment 2.

FIG. 14 is a flowchart showing a processing procedure performed by the DC according to Embodiment 2.

FIG. 15 is a schematic view illustrating one example of transmission and reception of messages performed between a DC and ECUs according to Embodiment 3.

FIG. 16 is a schematic view illustrating discard of a message by the DC according to Embodiment 3.

FIG. 17 is a flowchart showing the procedure of processing performed by the DC according to Embodiment 3.

### DETAILED DESCRIPTION OF PREFERRED EMBODIMENTS

Embodiments of the present disclosure are first listed and described. Furthermore, at least parts of the embodiments described below may arbitrarily be combined.

### Aspect (1)

An on-vehicle communication system according one aspect is an on-vehicle communication system comprising a plurality of on-vehicle communication devices connected to a common communication line and an on-vehicle communication control device connected to the common communication line and performing control related to communication between the plurality of on-vehicle communication devices. The plurality of on-vehicle communication devices are classified by a plurality of security levels, and a common key is specified for each of the security levels. An on-vehicle communication device of the on-vehicle communication devices includes a first storage unit that stores a common key according to a security level of the on-vehicle communication device, a first authentication code generation unit that generates an authentication code to be added to a message to be transmitted by using a common key stored in the first storage unit, and a first authentication code determination unit that determines whether or not an authentication code added to a received message is authorized by using a common key stored in the first storage unit. The on-vehicle communication control device includes a second storage unit that stores a common key for each of the security levels, a second authentication code determination unit that determines whether or not an authentication code added to a received message is authorized by using a corresponding common key stored in the second storage unit, and a second report unit that, if the second authentication code determination unit determines that an authentication code added to a received message is not authorized, makes a report to another one of the on-vehicle communication devices that does not store a common key used for the determination by the second authentication code determination unit.

In the present aspect, an on-vehicle communication control device and multiple on-vehicle communication devices are connected to a common communication line. The multiple on-vehicle communication devices are classified by multiple security levels, and a common key is specified for each security level. The on-vehicle communication device stores a common key according to a security level of the on-vehicle communication device itself, transmits a message to which an authentication code generated by using the stored common key is added, and determines whether or not an authentication code added to a received message is authorized. Messages with authentication codes generated by using different common keys are transmitted and received through the communication line, and thus each of the on-vehicle communication devices can determine the authorization status of a message to which an authentication code generated by the same common key as that of its own is added but cannot determine the authorization status of a message to which an authentication code generated by a common key different from that of its own is added.

The on-vehicle communication control device has stored common keys of the respective security levels and performs determination by using the common key corresponding to the authentication code added to the received message. Thus, the on-vehicle communication control device can determine whether or not the authentication code added to the message is authorized for all the messages transmitted and received through the common communication line. If receiving a message to which an unauthorized code is added, the on-vehicle communication control device makes a report to the on-vehicle communication device that does not store the common key used for this determination of the authentication code.

Thus, each of the on-vehicle communication devices can perform determination on a message that allows determination of the authorization status of the authentication code by using the common key stored by itself and can perform determination on a message that cannot determine the authorization status by itself by receiving a report from the on-vehicle communication control device, to thereby determine that an unauthorized message is transmitted to the common communication line, which allows the coexistence of the on-vehicle communication devices with different security levels.

### Aspect (2)

It is preferable that a plurality of authentication codes are able to be added to a message, the on-vehicle communication device stores a common key specified for a security level of the on-vehicle communication device and a common key specified for a security level lower than the security level in the first storage unit, and the first authentication code generation unit generates one or a plurality of authentication codes to be added to a message to be transmitted by using one or a plurality of common keys stored in the first storage unit.

In the present aspect, multiple authentication codes can be added to a message. The on-vehicle communication device stores a common key specified for a security level of the on-vehicle communication device itself and a common key specified for a security level lower than the security level of itself. The on-vehicle communication device storing the multiple common keys generates multiple authentication codes by using the multiple common keys and transmits a message to which the generated multiple authentication codes are added. This allows the on-vehicle communication device to transmit a message not only to an on-vehicle communication device having the same security level as that of the on-vehicle communication device of itself but also an on-vehicle communication device having a security level lower than the security level.

### Aspect (3)

It is preferable that the first authentication code determination unit of the on-vehicle communication device performs determination on an authentication code for which determination of an authorization status is allowed by using the one or plurality of common keys stored in the first storage unit of the on-vehicle communication device out of authentication codes added to a received message.

In the present aspect, the on-vehicle communication device having received a message to which multiple authentication codes are added determines the authorization status of at least one authentication code for which determination of the authorization status is allowed by using the common key held by itself. Thus, the on-vehicle communication device can determine whether or not a message is authorized and receive the message even if the message is transmitted from another on-vehicle communication device with the security level higher than that of the on-vehicle communication device of its own, if the message is a message with an authentication code for which the determination of the authorization status is allowed by using the common key stored by itself. Thus, the multiple on-vehicle communication devices connected to the common communication line can broadcast messages to multiple on-vehicle communication devices including the on-vehicle communication devices with different security levels.

### Aspect (4)

It is preferable that one authentication code is added to a message, the on-vehicle communication device stores one common key specified for a security level of the on-vehicle communication device in the first storage unit, and the first authentication code generation unit generates one authentication code to be added to another message to be transmitted by using the one common key stored in the first storage unit.

In the present aspect, one authentication code is added to a message. The on-vehicle communication device stores a common key specified for the security level of itself, generates an authentication code by using the common key and transmits a message to which the generated one authentication code is added. This makes it possible to simplify the configuration of each of the on-vehicle communication devices. This also makes it easy to separately handle the on-vehicle communication devices with different security levels.

### Aspect (5)

It is preferable that the on-vehicle communication control device comprises a second authentication code generation unit that, if the second authentication code determination unit determines that an authentication code added to a received message is authorized, generates another authentication code using a common key different from a common key used for the determination of the authentication code, and a relay unit that relays a message transmitted and received between the on-vehicle communication devices with different security levels by transmitting the received message to which the different authentication code generated by the second authentication code generation unit is added.

In the present aspect, the on-vehicle communication control device having stored common keys receives a message transmitted by the on-vehicle communication device, determines whether or not the received message is authorized, adds an authentication code generated by a common key different from the common key used for the determination to the message that is determined to be authorized and transmits the message to which the new authentication code is added to the common communication line. The on-vehicle communication control device can relay a message transmitted and received between the on-vehicle communication devices with different security levels. Each of the on-vehicle communication devices can transmit a message to all the on-vehicle communication devices connected to the common communication line via the on-vehicle communication control device.

### Aspect (6)

It is preferable that the on-vehicle communication device includes a first report unit that makes a report to the on-vehicle communication control device if the first authentication code determination unit determines that an authentication code added to a received message is not authorized, and the second report unit of the on-vehicle communication control device makes a report if the second authentication code determination unit determines that an authentication code added to a received message is not authorized and a report is received from the first report unit of the on-vehicle communication device.

In the present aspect, if it is determined that the authentication code added to the received message is not authorized, each of the on-vehicle communication devices makes a report to the on-vehicle communication control device. If the on-vehicle communication control device determines that the authentication code added to the message is not authorized by itself and a report from one of the on-vehicle communication devices is received, it makes a report to another one of the on-vehicle communication devices. This makes it possible to enhance reliability of the report from the on-vehicle communication control device to the on-vehicle communication device.

### Aspect (7)

It is preferable that the on-vehicle communication device periodically transmits a keep alive signal to the common communication line, and the first report unit makes a report to the on-vehicle communication control device by the keep alive signal.

In the present aspect, a report from the on-vehicle communication device to the on-vehicle communication control device is performed by a keep alive signal periodically transmitted from the on-vehicle communication device. This can prevent the normal transmission and reception of messages from being hindered by a report made from the on-vehicle communication device to the on-vehicle communication control device. The on-vehicle communication control device can detect an abnormality related to communication based on the information included in the keep alive signal and can detect any abnormality even if not receiving a keep alive signal.

### Aspect (8)

An on-vehicle communication system according to a present aspect is an on-vehicle communication system comprising a plurality of on-vehicle communication devices connected to a common communication line and an on-vehicle communication control device connected to the common communication line and performing control related to communication between the plurality of on-vehicle communication devices, and an encryption key is specified for each of the on-vehicle communication devices. An on-vehicle communication device of the on-vehicle communication devices includes a first storage unit that stores an encryption key specified for the on-vehicle communication device, and a first authentication code generation unit that generates an authentication code to be added to a message to be transmitted by using an encryption key stored in the first storage unit. The on-vehicle communication control device includes a second storage unit that stores an encryption key for each of the on-vehicle communication devices and a second authentication code determination unit that determines whether or not an authentication code added to a received message is authorized by using a corresponding encryption key stored in the second storage unit.

In the present aspect, respective encryption keys (possibly, common key or secret key and public key) are specified for the multiple on-vehicle communication devices connected to the communication line. Each of the on-vehicle communication devices stores the encryption key of itself and transmits a message to which an authentication code generated by using this encryption key is added. The on-vehicle communication control device has stored encryption keys specified for the respective on-vehicle communication devices connected to the common communication line and determines whether or not the authentication code added to a received message is authorized by using any one of the stored encryption keys. This makes it possible to separate the multiple on-vehicle communication devices connected to the common communication line in terms of security, and this allows the on-vehicle communication devices to individually transmit and receive messages with the on-vehicle communication control device, resulting in enhanced security.

### Aspect (9)

It is preferable that the on-vehicle communication device includes a first authentication code determination unit that determines whether or not an authentication code added to a received message is authorized by using an encryption key stored in the first storage unit, and the on-vehicle communication control device includes a second authentication code generation unit that, if the second authentication code determination unit determines that an authentication code added to a received message is authorized, generates a different authentication code by using an encryption key different from an encryption key used for the determination of this authentication code and a relay unit that relays a message transmitted and received between the on-vehicle communication devices with different security levels by transmitting the received message to which the different authentication code generated by the second authentication code generation unit is added.

In the present aspect, each of the on-vehicle communication devices determines whether or not the authentication code added to a received message is authorized by using the encryption key of itself. The on-vehicle communication control device, if determining that the authentication code added to a received message is authorized, generates an authentication code using an encryption key different from the encryption key used for the determination and transmits a message to which the generated authentication code is added. Thus, the on-vehicle communication control device can relay a message transmitted and received between the on-vehicle communication devices. The on-vehicle communication device can transmit and receive a message with another on-vehicle communication device by interposing the on-vehicle communication control device therebetween.

### Aspect (10)

It is preferable that the on-vehicle communication control device performs determination by the second authentication code determination unit before completion of transmission of a message, and a discard processing unit that performs processing of causing the on-vehicle communication device to discard the message before completion of transmission of the message if the second authentication code determination unit determines that an authentication code added to the message is not authorized.

In the present aspect, before completion of transmission of a message to the on-vehicle communication device, the on-vehicle communication control device determines whether or not the authentication code added to the message is authorized. The on-vehicle communication control device performs processing of causing multiple on-vehicle communication devices connected to the common communication line to discard the message before completion of the transmission of the message if determining that the authentication code is not authorized. Thus, each of the on-vehicle communication devices does not need to determine the authorization status of the authentication code added to the message and can receive a message that is not caused to discard by the on-vehicle communication control device without determining the authorization status of the authentication code and use it for the processing after that.

### Aspect (11)

An on-vehicle communication control device according to an aspect is an on-vehicle communication control device connected to a common communication line to which a plurality of on-vehicle communication devices are connected and performing control related to communication between the plurality of on-vehicle communication devices. The plurality of on-vehicle communication devices are classified by a plurality of security levels, and a common key is specified for each of the security levels. The on-vehicle communication control device comprises: a storage unit that stores a common key for each of the security levels; an authentication code determination unit that determines whether or not an authentication code added to a received message is authorized by using a corresponding common key stored in the storage unit; and a report unit that, if the authentication code determination unit determines that an authentication code added to a received message is not authorized, makes a report to another one of the on-vehicle communication devices that does not store a common key used for the determination by the authentication code determination unit.

In the present aspect, coexistence of the on-vehicle communication devices with different security levels can be achieved similarly to the aspect (1).

### Aspect (12)

It is preferable that the on-vehicle communication control device further comprises an authentication code generation unit that, if the authentication code determination unit determines that an authentication code added to a received message is authorized, generates a different authentication code by using a common key different from a common key used for the determination of the authentication code; and a relay unit that relays a message transmitted and received between the on-vehicle communication devices with different security levels by transmitting the received message to which the different authentication code generated by the authentication code generation unit is added.

In the present aspect, the on-vehicle communication control device can relay a message transmitted and received between the on-vehicle communication devices with different security levels similarly to the aspect (5).

### Aspect (13)

It is preferable that the on-vehicle communication device makes a report if it is determined that an authentication code added to a received message is not authorized, and the report unit makes a report if the authentication code determination unit determines that an authentication code added to a received message is not authorized and a report from the on-vehicle communication device is received.

In the present aspect, it is possible to enhance reliability of the report from the on-vehicle communication control device to the on-vehicle communication device similarly to the aspect (6).

### Aspect (15)

An on-vehicle communication device according to one aspect is an on-vehicle communication device connected to a common communication line, and a plurality of on-vehicle communication devices connected to the common communication line are classified by a plurality of security levels, and a common key is specified for each of the security levels. The on-vehicle communication device comprises a storage unit that stores a common key according to a security level of the on-vehicle communication device; an authentication code generation unit that generates an authentication code to be added to a message to be transmitted by using a common key stored in the storage unit; an authentication code determination unit that determines whether or not an authentication code added to a received message is authorized by using a common key stored in the storage unit; and a report unit that makes a report to another one of the on-vehicle communication devices connected to the common communication line if the authentication code determination unit determines that an authentication code added to a received message is not authorized.

In the present aspect, it is possible to enhance reliability of the report from the on-vehicle communication control device to the on-vehicle communication device similarly to the aspect (6).

Aspect (15)

It is preferable that the report unit makes a report by a keep alive signal periodically transmitted to the common communication line.

In the present aspect, it is possible to prevent the normal transmission and reception of messages from being hindered by a report made from the on-vehicle communication device to the on-vehicle communication control device similarly to the aspect (7).

### Aspect (16)

It is preferable that a plurality of authentication codes are able to be added to a message, the storage unit stores a common key specified for a security level of the on-vehicle communication device and a common key specified for a security level lower than the security level, and the authentication code generation unit generates one or plurality of authentication codes to be added to a message to be transmitted by using one or plurality of common keys stored in the storage unit.

In the present aspect, the on-vehicle communication device can transmit a message not only to an on-vehicle communication device having the same security level as that of the on-vehicle communication device itself but also an on-vehicle communication device having a security level lower than the security level thereof similarly to the aspect (2).

### Aspect (17)

It is preferable that the authentication code determination unit performs determination on an authentication code for which determination of an authorization status is allowed by using the one or plurality of common keys stored in the storage unit of the on-vehicle communication device out of authentication codes added to a received message.

In the present aspect, the multiple on-vehicle communication devices connected to the common communication line can broadcast messages to multiple on-vehicle communication devices including the on-vehicle communication devices with different security levels similarly to the aspect (3).

### Aspect (18)

It is preferable that one authentication code is added to a message, the storage unit stores one common key specified for a security level of the on-vehicle communication device, and the authentication code generation unit generates one authentication code to be added to another message to be transmitted by using the one common key stored in the storage unit.

In the present aspect, it is possible to simplify the configuration of each of the on-vehicle communication devices, and it is easy to separately handle the on-vehicle communication devices with different security levels similarly to the aspect (4).

### Aspect (19)

A communication control method according to an aspect is a communication control method for, by an on-vehicle communication control device that is connected to a common communication line to which a plurality of on-vehicle communication devices are connected, performing control related to communication between the plurality of on-vehicle communication devices. The plurality of on-vehicle communication devices are classified by a plurality of security levels, and a common key is specified for each of the security levels. The communication control method comprises: storing a common key according to each of the security levels in a storage unit; determining whether or not an authentication code added to a received message is authorized by using a corresponding common key stored in the storage unit; and making, if an authentication code added to a received message is not authorized, a report to another one of the on-vehicle communication devices that does not store a common key used for this determination.

In the present aspect, coexistence of the on-vehicle communication devices with different security levels can be achieved similarly to the aspect (11).

### Aspect (20)

A communication method according to an aspect is a communication method for performing processing related to communication between on-vehicle communication devices connected to a common communication line. The plurality of on-vehicle communication devices connected to the common communication line are classified by a plurality of security levels, and a common key is specified for each of the security levels. The communication method comprises: storing a common key according to a security level of an on-vehicle communication device in a storage unit; generating an authentication code to be added to a message to be transmitted by using a common key stored in the storage unit; determining whether or not an authentication code added to a received message is authorized by using a common key stored in the storage unit; and making a report to another one of the on-vehicle communication devices connected to the common communication line if it is determined that an authentication code added to a received message is not authorized.

In the present aspect, it is possible to enhance reliability of the report from the on-vehicle communication control device to the on-vehicle communication devices similarly to the aspect (14).

Specific examples of an on-vehicle communication system according to the present disclosure will be described below in details with reference to the drawings depicting embodiments. The scope of the present disclosure is defined by the appended claims, and all changes that fall within the meanings and the bounds of the claims, or equivalence of such meanings and bounds are intended to be embraced by the claims.

### Embodiment 1

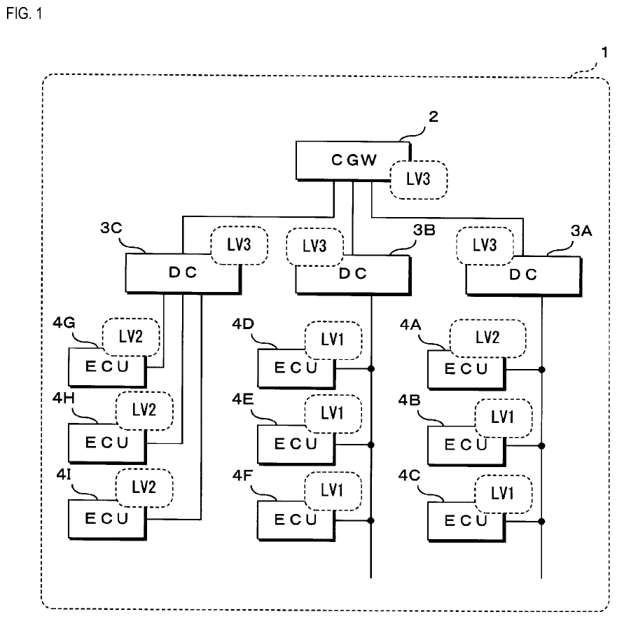

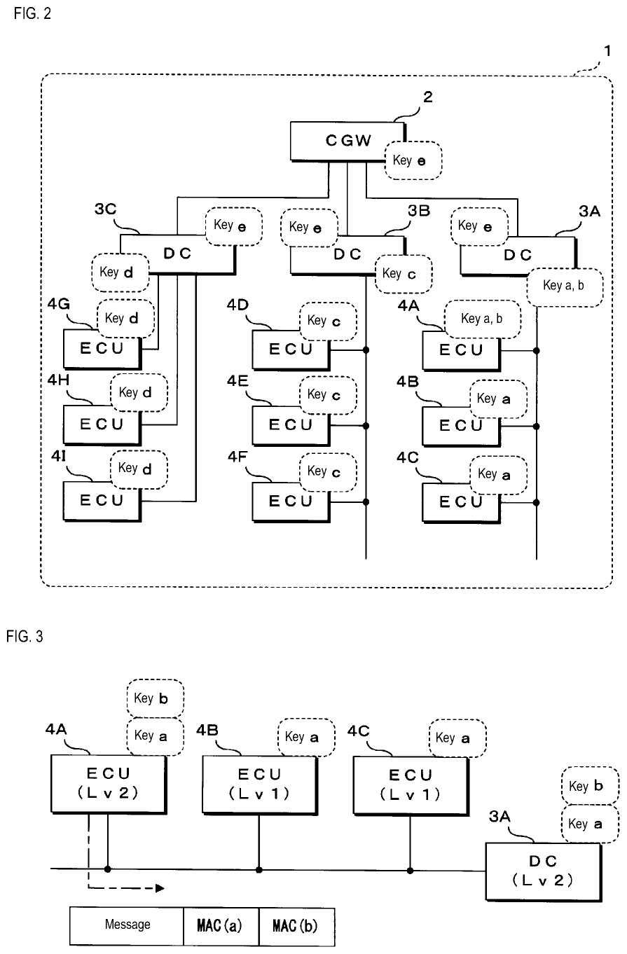

FIGS. 1 and 2 are schematic views illustrating the outline of an on-vehicle communication system according to the present embodiment. The on-vehicle communication system according to the present embodiment is composed of a central gate way (CGW) 2 mounted on a vehicle 1, three domain controllers (DCs) 3A to 3C and nine electronic control units (ECUs) 4A to 4I that are mounted on the vehicle 1. The CGW 2 is connected to the three DCs 3A to 3C through individual communication lines. The DC 3A is connected to the three ECUs 4A to 4C through a common communication line (so-called bus). The DC 3B is connected to the three ECUs 4D to 4F through a bus. The DC 3C is connected to the three ECUs 4G to 4I through individual communication lines.

In the present embodiment, a system is constructed in which the plurality of ECUs 4A to 4I are classified according to functions for the vehicle 1, for example, and one of the DCs 3A to 3C is provided for each function and connected to corresponding ones of the ECUs 4A to 4I through the communication line, and the plurality of DCs 3A to 3C are connected with each other via the CGW 2. The DCs 3A to 3C control the operation of the corresponding ECUs 4A to 4I connected thereto and achieve respective functions of the vehicle 1. The DCs 3A to 3C cooperate with each other by exchanging information to bring their functions into associated with each other, resulting in achieving a function as the entire vehicle 1.

The CGW 2 and the three DCs 3A to 3C perform communication according to a communication protocol such as the Ethernet (registered trademark), for example, to transmit and receive messages. The CGW 2 transmits a message received from one of the DCs 3A to 3C to the other two of the DCs 3A to 3C to thereby relay messages transmitted and received between the three DCs 3A to 3C. This allows the DCs 3A to 3C to transmit and receive a message with each other via the CGW 2. In the present embodiment, though the CGW 2 is a device for merely relaying a message transmitted and received to and from the three DCs 3A to 3C, it may perform more sophisticated processing such as performing computational processing on the message received from one of the DCs 3A to 3C and transmitting the computational result to another one of the DCs 3A to 3C as a message, for example.

The DC 3A and the three ECUs 4A to 4C perform communication according to a CAN communication protocol, for example, to thereby transmit and receive messages via a CAN bus. The message transmitted by one of the ECUs 4A to 4C can be received by another one of the ECUs 4A to 4C and the DC 3A. The message transmitted by the DC 3A can be received by the ECUs 4A to 4C.

Similarly, the DC 3B and the three ECUs 4D to 4F perform communication according to a CAN communication protocol, for example, to thereby transmit and receive messages via a CAN bus. The message transmitted by one of the ECUs 4D to 4F can be received by another one of the ECUs 4D to 4F and the DC 3B. The message transmitted by the DC 3B can be received by the ECUs 4D to 4F.

The DC 3C and the three ECUs 4G to 4I perform communication according the Ethernet communication protocol, for example, to transmit and receive messages. The DC 3C and the ECUs 4G to 4I are connected to each other through individual communication lines and perform one-to-one transmission and reception of messages. The DC 3C transmits a message received from any one of the ECUs 4G to 4I to another one of the ECUs 4G to 4I to thereby relay the message transmitted and received between the three ECUs 4G to 4I. This allows the ECUs 4G to 4I to transmit and receive messages with another one of the ECUs 4G to 4I via the DC 3B.

In addition, a message can also be transmitted from the ECU 4A connected to DC 3A to the ECU 4I connected to the DC 3C, for example. Here, the message transmitted from the ECU 4A is relayed via the DC 3A, the CGW 2 and the DC 3 to the ECU 4I. As such, the CGW 2 and the DCs 3A to 3C relay a message to allow the ECUs 4A to 4I to transmit and receive the message therebetween.

In the on-vehicle communication system according to the present embodiment, a security level is set for each of the devices forming of the system. As illustrated in FIG. 1, the security level 3 is set to the CG W2 and the three DCs 3A to 3C, the security level 2 is set to the ECUs 4A and 4G to 4I and the security level 1 is set to the ECUs 4B to 4F in this example. In FIG. 1, the security level of each device is denoted by a label of “LV?.” The security level indicates higher security performance as the numerical value is greater.

In the on-vehicle communication system according to the present embodiment, a message authentication code (MAC) is added to a message to be transmitted and received between the devices. The message includes data on, for example, an ID indicating the type of a message, information to be shared between the devices, etc. The MAC is information obtained by performing encryption processing using a predetermined encryption key on the data included in the message. Each device generates a MAC by using an encryption key held by itself and transmits a message to which the generated MAC is added. Each device having received this message determines whether or not the MAC added to the message is authorized by using an encryption key held by itself. Here, each device performs encryption processing on the data included in the received message by using the encryption key to generate a MAC and determines if the MAC is authorized depending on whether the MAC generated by the device and the MAC added to the massage match each other.

In the present embodiment, the devices between which messages are transmitted and received store a common encryption key, that is, a shared key and perform generation and determination of a MAC. In FIG. 2, the encryption key held by each of the devices is denoted by any one of keys a to e encircled with a dotted line. For example, the CGW 2 with the security level 3 and the DCs 3A to 3C with the security level 3 perform generation and determination of a MAC using the key e for the security level 3. The DC 3B with the security level 3 and the ECUs 4D to 4F with the security level 1 perform generation and determination of a MAC using the key c for the security level 1. If relaying a message from the ECUs 4D to 4F to the CGW 2, for example, the DC 3B deletes the MAC generated by using the key c from the received message and transmits a message to which a MAC generated by using the key e is added to the CGW 2. If relaying a message from the CGW 2 to the ECUs 4D to 4F, for example, the DC 3B deletes the MAC generated by using the key e from the received message and transmits a message to which a MAC generated by using the key c is added to the ECUs 4D to 4F.

Similarly, the DC 3C with the security level 3 and the ECUs 4G to 4I with the security level 2 perform generation and determination of a MAC using a key d for the security level 2. If relaying a message from the ECUs 4G to 4I to the CGW 2, for example, the DC 3C deletes the MAC generated by using the key d from the received message and transmits a message to which a MAC generated by using the key e is added to the CGW 2. If relaying a message from the CGW 2 to the ECUs 4G to 4I, for example, the DC 3C deletes the MAC generated by using the key e from the received message and transmits a message to which a MAC generated by using the key d is added to the ECUs 4G to 4I.

In the on-vehicle communication system according to the present embodiment, for each of the groups of the DCs 3A to 3C and the ECUs 4A-4I classified according to the function of the vehicle 1, for example, the encryption keys for generation and determination of a MAC used for communication between the groups can be made different. Thus, the multiple devices forming of the on-vehicle communication system can be separated into multiple groups in terms of security, and a security levels suitable for each of the groups can be set. The security level is defined depending on, for example, the intensity of an algorithm of the encryption processing used for generation of a MAC, the information amount (bit length) of the encryption key used for the encryption processing or the like. As the intensity of the algorithm of the used encryption processing is higher and the information amount of the encryption key is more, the security level is higher.

In the on-vehicle communication system according to the present embodiment, as shown in the DC 3A and the ECUs 4A to 4C in FIGS. 1 and 2, even in a single (common) physical network configuration, multiple security levels can coexist. Transmission and reception of messages using two encryption keys including the key a for the security level 1 and the key b for the security level 2 is performed among the DC 3A with the security level 3, the ECU 4A with the security level 2 and the ECUs 4B, 4C with the security level 1. The following describes transmission and reception of messages in the network where security levels coexist.

FIG. 3 is a schematic view illustrating one example of transmission and reception of messages performed between the DC 3A and the ECUs 4A to 4C. As described above, the DC 3A and the ECUs 4A to 4C are connected to the common CAN bus, and transmit and receive messages according to the CAN communication protocol. In the illustrated example, the level 1 or 2 (denoted by Lv1 or Lv2 in the drawing) is set as a security level of each of the devices. In this example, the greater the numerical value is, the higher the security level is, and thus the level 2 has a higher security level than the level 1. The DC 3A and the ECU 4A are set to the security level 2 while the ECUs 4B and 4C are set to the security level 1. In the present example, the key a is set as an encryption key for the security level 1 while the key b is set as an encryption key for the security level 2. For example, the key b has a longer bit length than the key a.

In the on-vehicle communication system according to the present embodiment, each device stores an encryption key corresponding to the security level of itself and an encryption key corresponding to the security level lower than the security level of itself. For example, the ECUs 4B and 4C with the security level 1 each store the key a corresponding to the security level 1 of itself. For example, the DC 3A and the ECU 4A with the security level 2 each store the key b corresponding to the security level 2 of itself and the key a corresponding to the security level 1 lower than the security level 2 of itself.

For example, the ECU 4A with the security level 2 storing the two keys a, b adds a MAC (a) generated using the key a and a MAC (b) generated using the key b to a message to be transmitted, and transmits the message to the CAN bus. The ECUs 4B and 4C with the security level 1 having received the message each determine whether or not the MAC (a) is authorized by using the key a stored by itself and do not determine (cannot determine) whether or not the MAC (b) is authorized. If the MAC (a) added to the message is authorized, the ECUs 4B and 4C each determine that this message is authorized. The DC 3A with the security level 2 having received this message determines whether or not the MAC (b) is authorized by using the key b stored by itself and determines whether or not the MAC (a) is authorized by using the key a. The DC 3A determines that this message is authorized if the MAC (b) and the MAC (a) are authorized. It is noted that the DC 3A may determine whether or not only the MAC (b) having a higher security level is authorized and needs not determine whether or not the MAC (a) having a lower security level is authorized.

For example, the ECU 4B with the security level 1 storing one key a adds a MAC (a) generated by using the key a to a message to be transmitted, and transmits the message to the CAN bus. The DC 3A and the ECUs 4A and 4C having received this message each determine whether or not the MAC (a) is authorized by using the key a stored by itself. The DC 3A and the ECUs 4A and 4C determine that this message is authorized if the MAC (a) is authorized.

For a message that is not required for the ECUs 4B and 4C with the security level 1, the ECU 4A with the security level 2 storing the two keys a, b may transmit a message to which only the MAC (b) is added, for example. The ECUs 4B and 4C not storing the key b cannot determine whether or not the message to which only the MAC (b) is added is authorized and thus discard it. This message is received by the DC 3A storing the key b.

Here, if a malignant device is connected to the CAN bus, or if any one of the devices is abused, for example, a message including an unauthorized MAC may be transmitted on the CAN bus. A message to which an unauthorized MAC (a) is added is determined to be unauthorized by all the DC 3A and the ECUs 4A to 4C, and thus each device can perform processing of discarding the message or the like. In contrast thereto, a message to which an authorized MAC (a) and an unauthorized MAC (b) are added can be determined to be unauthorized by the DC3 and the ECU 4A storing the key b but cannot be determined to be unauthorized by the ECUs 4B and 4C not storing the key b.

Hence, in the on-vehicle communication system according to the present embodiment, if receiving a message to which an unauthorized MAC is added, the DC 3A makes a report to the ECUs 4A to 4C. The DC 3A makes a report to the ECUs 4A to 4C having a security level lower than that of the MAC that is determined to be unauthorized. For example, if determining that the MAC (b) with the security level 2 is unauthorized, the DC 3A makes a report to the ECUs 4B, 4C with the security level 1 having a lower security level than the security level 2 and does not make a report to the ECU 4A with the security level 2. It is noted that the DC 3A may be configured to make a report to all the ECUs 4A to 4C regardless of the security level. If determining that the MAC (a) with the security level 1 is unauthorized, the DC 3A needs not to make a report since there exists no security level lower than the security level 1.

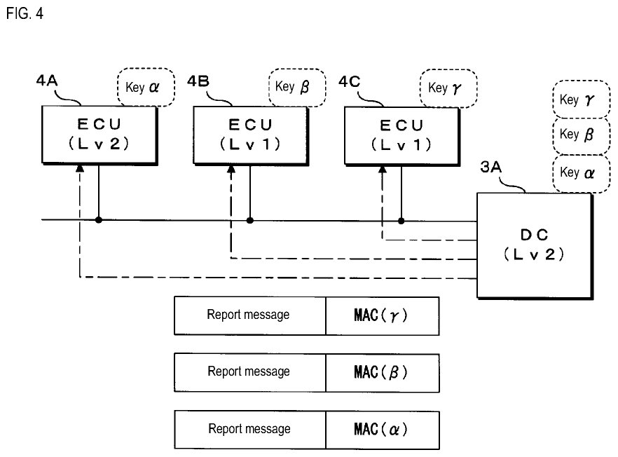

FIG. 4 is a schematic view illustrating one example of making a report from the DC 3A to the ECUs 4A to 4C. In the on-vehicle communication system according to the present embodiment, each of the devices stores an encryption key used for transmission and reception of a report message when an abnormality such as detection of an unauthorized MAC or the like in addition to an encryption key used for transmission and reception of a normal message. In the illustrated example, the ECU 4A stores a key a, the ECU 4B stores a key (3, and the ECU 4C stores a key y. That is, the devices that can receive a report message store different encryption keys for report. The DC 3A stores keys α, β, γ of the respective ECUs 4A to 4C that can be transmission destinations of a report message. The key α is an encryption key for the security level 2 while the keys β, γ are encryption keys for the security level 1. In the present embodiment, though the keys α, β, γ are, not limited thereto, assumed as shared keys. In some embodiment, the keys α, β, γ respectively held by the ECUs 4A to 4C may be secret keys while the keys α, β, γ held by the DC 3A may be public keys corresponding to the secret keys.

If detecting any abnormality or the like and transmitting a report message to the ECUs 4A to 4C, the DC 3A independently transmits a report message to the ECUs 4A to 4C that require a report. If transmitting a report message to the ECU 4A, the DC 3A transmits a report message with a MAC (a) that is generated by using the key a held by the ECU 4A. Since the report message to which the MAC (α) is added allows only the ECU 4A having the key a to determine the authentication status, this is received only by the ECU 4A while being discarded by the ECUs 4B and 4C. Similarly, if transmitting a report message to the ECU 4B, the DC 3A transmits a report message with a MAC (β) that is generated by using the key β held by the ECU 4B.

Thus, even if any one of the ECUs 4A to 4C is abused, for example, keys for transmission and reception of report messages held by the rest of the ECUs 4A to 4C are not leaked out, which can prevent transmission of report messages from the DC 3A to the ECUs 4A to 4C from being hindered.

In the present example, since the ECU 4A can determine the authorization status for both of the MAC (α) and the MAC (b) and does not require a report message from the DC 3A in response to detection of an unauthorized MAC, the ECU 4A does not need to store the key α to transmit and receive a report message. It is noted that if making a report other than detection of an unauthorized MAC, the DC 3A may transmit a report message with the MAC (α) by using the key α, and thus the ECU 4A preferably stores the key α.

Alternatively, the DC 3A may be configured to transmit a report message to which multiple MACs are added. For example, if transmitting a report message to the ECUs 4B, 4C, the DC 3A may transmit a report message to which the MAC (β) and the MAC (γ) are added. If each of the ECUs 4B, 4C having received this report message determines that any of the MACs is authorized by using the key β, γ stored by itself, they handle the report message as an authentication message.

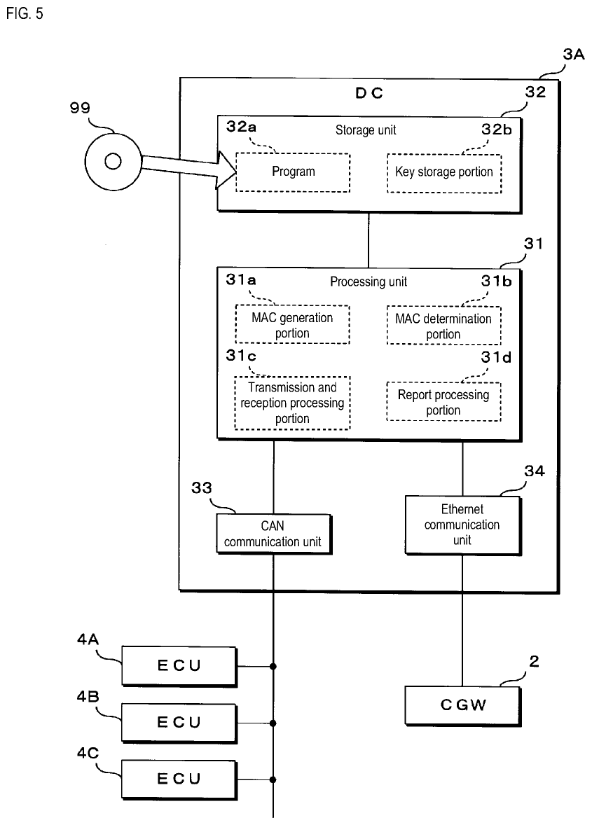

FIG. 5 is a block diagram illustrating the configuration of the DC 3A according to the present embodiment. It is noted that the other DC 3B and 3C have similar configuration to the DC 3A, and thus the illustration and the detailed description thereof will not be made here. The DC 3A according to the present embodiment is composed of a processing unit (processor) 31, a storage unit (storage) 32, a CAN communication unit (transceiver) 33 and an Ethernet communication unit (transceiver) 34, etc. The processing unit 31 is constituted by a computational processing device such as a central processing unit (CPU), a micro-processing unit (MPU) or the like. The processing unit 31 reads and executes a program 32a stored in the storage unit 32 to thereby transmit and receive messages with the CGW 2 and the ECUs 4A to 4C, detect an unauthorized message based on a MAC and make a report to the ECUs 4A to 4C, for example.

The storage unit 32 is constituted by, for example, a nonvolatile memory element such as a flash memory, an electrically erasable programmable read only memory (EEPROM) or the like.

The storage unit 32 stores various programs to be executed by the processing unit 31 and various data required for the processing by the processing unit 31. In the present embodiment, the storage unit 32 stores a program 32a to be executed by the processing unit 31 and is provided with a key storage portion 32b storing an encryption key used for generation and determination of a MAC. It is noted that the program 32a may be written to the storage unit 32 at the manufacturing stage of the DC 3A, for example, may be acquired by the DC 3A communicating with a remote server device that delivers the program, for example. Alternatively, the program 32a recorded in a recording medium 99 such as a memory card, an optical disk or the like may be read out and stored in the storage unit 32 by the DC 3A, for example, or a program recorded in the recording medium 99 may be read out and written into the storage unit 32 of the DC 3A by a writing device, for example. The program 32a may be provided as delivery through a network or may be provided in such a manner as to be recorded in the recording medium 99.

The key storage portion 32b of the storage unit 32 stores the keys a, b used for generation and determination of MACs that are to be added to messages transmitted and received to and from the ECUs 4A to 4C and the key e used for generation and determination of a MAC to be added to messages that are transmitted and received to and from the CGW 2. The key storage portion 32b also stores the keys α, β, γ used for generation and determination of a MAC to be added to the report messages transmitted and received to and from the ECUs 4A to 4C when an abnormality is detected. It is noted that the encryption keys stored in the encryption key storage portion 32b are different among the DCs 3A to 3C.

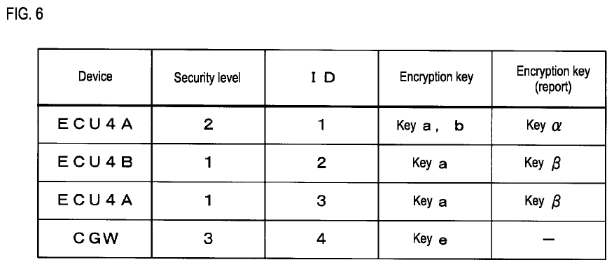

Furthermore, the DC 3A stores information on the multiple encryption keys stored in the key storage portion 32b as a table, for example. FIG. 6 is a schematic view illustrating one example of information on the encryption keys stored in a table. In the exemplified table, devices as partners to and from which messages from the DC 3A are transmitted and received, the security levels of these device, IDs (for example, CAN-ID) added to messages to be transmitted by these devices, encryption keys stored in these devices and encryption keys for report a message stored in the devices are stored in correspondence with each other. If receiving a message or the like from any one of the ECUs 4A to 4C, for example, the DC 3A can judges the device as a transmission source of the message based on the ID added to the message and determine the MAC by reading out the corresponding encryption key from the key storage portion 32b.

The CAN communication unit 33 performs wired communication according to the CAN communication protocol.

The CAN communication unit 33 can be constituted by a so-called CAN transceiver IC. The CAN communication unit 33 is connected to the multiple ECUs 4A to 4C through the CAN bus placed in the vehicle 1 and performs communication with these ECUs 4A to 4C according to the CAN communication protocol. The CAN communication unit 33 converts a message to be transmitted that is provided from the processing unit 31 into an electrical signal according to the CAN communication protocol and outputs the signal to the communication line to thereby transmit a message to the ECUs 4A to 4C. The CAN communication unit 33 samples electric potential of the communication line to thereby receive a message from one of the ECUs 4A to 4C and provides the processing unit 31 with the received message.

The Ethernet communication unit 34 performs wired communication according to the Ethernet communication protocol.

The Ethernet communication unit 34 is connected to the CGW 2 through the communication line for the Ethernet placed in the vehicle 1 and performs communication according to the Ethernet communication protocol with the CGW 2. The Ethernet communication unit 34 converts a message to be transmitted provided from the processing unit 31 into an electrical signal according to the Ethernet communication protocol and outputs the signal to the communication line to thereby transmit a message to the CGW 2. Moreover, the Ethernet communication unit 34 receives a message from the CGW 2 by sampling electric potential of the communication line and provides the processing unit 31 with the received message. In the system configuration exemplified in FIGS. 1 and 2, the DC 3C is provided with multiple Ethernet communication units 34 instead of the CAN communication unit 33.

In the DC 3A according to the present embodiment, the processing unit 31 reads and executes the program 32a stored in the storage unit 32 to thereby cause a MAC generation portion 31a, a MAC determination portion 31b, a transmission and reception processing portion 31c, a report processing portion 31d, etc. to act as functional blocks in terms of software. The MAC generation portion 31a performs encryption processing using an encryption key stored in the key storage portion 32b on the message to be transmitted to the CGW 2 or the ECUs 4A to 4C to thereby perform processing of generating a MAC for authenticating this message. The MAC generation portion 31a performs generation of a MAC using the key e stored in the key storage portion 32b on the message to be transmitted to the CGW 2. Furthermore, the MAC generation portion 31a performs generation of a MAC using the key a stored in the key storage portion 32b and generation of a MAC using the key b stored in the key storage portion 32b on the message to be transmitted to the ECUs 4A to 4C.

The MAC determination portion 31b performs processing of determining whether or not a MAC added to the massage received from the CGW 2 or the ECUs 4A to 4C is authorized. The MAC determination portion 31b judges the encryption key to be used for determination with reference to the table shown in FIG. 5 using the ID included in the received message. The MAC determination portion 31b performs generation of a MAC using an encryption key on the received message and determines if a MAC is authorized depending on whether or not the generated MAC and the MAC added to the received message match each other. The MAC determination portion 31b performs processing of determining a MAC using the key e stored in the key storage portion 32b on the message received from the CGW 2. The MAC determination portion 31b performs determination of a MAC using the keys a, b stored in the key storage portion 32b on the message received from the ECU 4A. The MAC determination portion 31b performs determination of a MAC using the key a stored in the key storage portion 32b on the message received from the ECUs 4B, 4C.

The transmission and reception processing portion 31c performs processing of transmitting and receiving messages to and from the CGW 2 or the ECUs 4A to 4C. The transmission and reception processing portion 31c adds a MAC generated by the MAC generation portion 31a to a message to be transmitted and provides the CAN communication unit 33 or the Ethernet communication unit 34 with the message to which the MAC is added to thereby transmit the message to the ECUs 4A to 4C or the CGW 2. Based on the determination performed by the MAC determination portion 31b on whether or not the MAC added to the message received by the CAN communication unit 33 or the Ethernet communication portion 34 is authorized, the transmission and reception processing portion 31c handles a message with an authorized MAC as the reception message while discarding a message with an unauthorized MAC.

The report processing portion 31d performs processing of transmitting a report message to the ECUs 4A to 4C if the MAC determination portion 31b determines that a MAC is unauthorized. The report processing portion 31d checks the security level of the MAC that is determined to be unauthorized by the MAC determination portion 31b and transmits a report message to the ECUs 4A to 4C that do not have the encryption key corresponding to this security level, that is, to the ECUs 4A to 4C having a security level lower than this security level in this embodiment. The report message includes, for example, information on the security level of the MAC that is determined to be unauthorized, the ID included in the message with this MAC, the identification information of the ECUs 4A to 4C as a transmission source of this message, etc. Each of the ECUs 4A to 4C having received a report message stores the information included in the report message and can perform processing of discarding a similar message if receiving it thereafter.

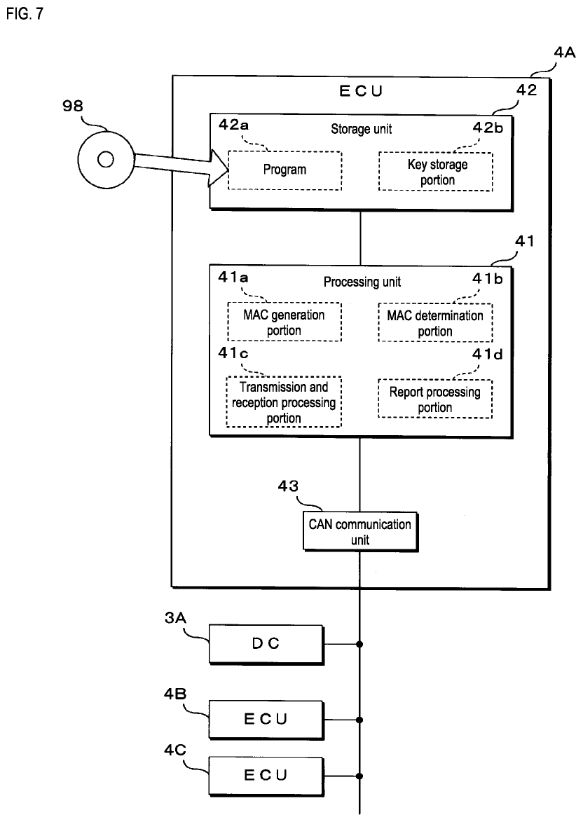

FIG. 7 is a block diagram illustrating the configuration of the ECU 4A according to the present embodiment. It is noted that the other ECUs 4B to 4I each have a similar configuration to the ECU 4A and thus the illustration and description thereof will not be made here. The ECU 4A according to the present embodiment is composed of a processing unit (processor) 41, a storage unit (storage) 42, a CAN communication unit (transceiver) 43, etc. The processing unit 41 is constituted by a computational processing device such as a CPU, an MPU or the like. The processing unit 41 reads and executes a program 42a stored in the storage unit 42 to thereby transmit and receive messages to and from the DC 3A and the ECUs 4B, 4C and detect an unauthorized message based on a MAC, for example.

The storage unit 42 is constituted by, for example, a nonvolatile memory element such as a flash memory, an EEPROM or the like. The storage unit 42 stores various programs to be executed by the processing unit 41 and various data required for the processing by the processing unit 41. The storage unit 42 in the present embodiment stores a program 42a to be executed by the processing unit 41 and is provided with a key storage portion 42b storing an encryption key used for generation and determination of a MAC. It is noted that the program 42a may be written to the storage unit 42 at the manufacturing stage of the ECU 4A, for example, and may be acquired by the ECU 4A communicating with a remote server device that delivers the program, for example. Alternatively, the program 42a recorded in a recording medium 98 such as a memory card, an optical disk or the like may be read out and stored in the storage unit 42 by the ECU 4A, for example, or a program recorded in the recording medium 98 may be read out and written into the storage unit 42 of the ECU 4A by a writing device, for example. The program 42a may be provided as delivery through a network or may be provided in such a manner as to be recorded in the recording medium 98.

The key storage portion 42b of the storage unit 42 stores keys a, b used for generation and determination of a MAC that is to be added to messages that are transmitted and received to and from the DC 3A and another one of the ECUs 4B, 4C. The key storage portion 42b also stores a key a used for generation and determination of a MAC to be added to a report message that is transmitted and received to and from the DC 3A when an abnormality is detected. It is noted that the encryption keys stored in the encryption key storage portion 42b are different among the ECUs 4A to 4I.

The CAN communication unit 43 performs wired communication according to the CAN communication protocol. The CAN communication unit 43 can be constituted by a so-called CAN transceiver IC. The CAN communication unit 43 is connected to the DC 3A and the other ECUs 4B, 4C through the CAN bus placed within the vehicle 1 and performs communication with the DC 3A and another one of the ECUs 4B, 4C according to the CAN communication protocol. The CAN communication unit 43 converts a message to be transmitted that is provided from the processing unit 41 into an electrical signal according to the CAN communication protocol and outputs the signal to the communication line to thereby transmit a message to the DC 3A and the ECUs 4B and 4C. The CAN communication unit 43 samples electric potential of the communication line to thereby receive a message from the DC 3A and the ECUs 4B, 4C and provides the processing unit 41 with the received message.

In the system configuration exemplified in FIGS. 1 and 2, each of the ECUs 4G to 4I is provided with an Ethernet communication unit that performs communication according to the Ethernet communication protocol instead of the CAN communication unit 43.

In the ECU 4A according to the present embodiment, the processing unit 41 reads and executes the program 42a stored in the storage unit 42 to thereby cause a MAC generation portion 41a, a MAC determination portion 41b, a transmission and reception processing portion 41c, a report processing portion 41d, etc. to act as functional blocks in terms of software. The MAC generation portion 41a performs encryption processing using an encryption key stored in the key storage portion 42b on a message to be transmitted to the DC 3A and the ECUs 4B, 4C to thereby perform generation of a MAC for authenticating this message. The MAC generation portion 41a performs generation of a MAC using the key a stored in the key storage portion 32b and generation of a MAC using the key b stored in the key storage portion 32b.

The MAC determination portion 41b performs processing of determining whether or not a MAC added to the massage received from the DC 3A or the ECUs 4B, 4C is authorized. The MAC determination portion 41b generates a MAC using an encryption key on the received message and determines if the MAC is authorized depending on whether or not the generated MAC and the MAC added to the received message match each other. If two MACs are added to the received message, the MAC determination portion 41b determines whether each MAC is authorized by using the keys a, b corresponding to the MACs. If one MAC is added to the received message, the MAC determination portion 41b determines whether each MAC is authorized by using one key a.

The transmission and reception processing portion 41c performs processing of transmitting and receiving messages to and from the DC 3A and any one of the ECUs 4B, 4C. The transmission and reception processing portion 41c adds a MAC generated by the MAC generation portion 41a to a message to be transmitted and provides the CAN communication unit 43 with the message with the MAC to thereby transmit the message to the DC 3A and the ECUs 4B, 4C. Based on the determination performed by the MAC determination portion 41b on whether or not the MAC added to the message received by the CAN communication unit 43 is authorized, the transmission and reception processing portion 41c handles a message with an authorized MAC as the reception message while discarding a message with an unauthorized MAC.

The report processing portion 41d makes a report that the ECU 4A of its own normally operates to the DC 3A and the ECUs 4B, 4C by transmitting a signal to the CAN bus at a predetermined cycle. This periodic transmission of signals by the report processing portion 41d is a so-called keep alive function, and the signal periodically transmitted is called a keep alive signal below. In the present embodiment, the report processing portion 41d, if the MAC determination portion 41d determines that a MAC is unauthorized, makes a report that an unauthorized MAC is detected to the DC 3A by transmitting a keep alive signal including information on the unauthorized determination. At this time, the report processing portion 41d can incorporate the information on, for example, the number of detections of unauthorized MAC, the security level of the MAC determined to be unauthorized, the ID of the message to which the MAC determined to be unauthorized is added or the like.

In the on-vehicle communication system according to the present embodiment, the DC 3A transmits a report message in response to detection of an unauthorized MAC as described above. The transmission timing of the report message by the DC 3A can employ the following three variations. The DC 3A may employ any of the three transmission timings related to the report message.
(1) Instantaneous Report
(2) Single consensus Report
(3) Multi-consensus Report

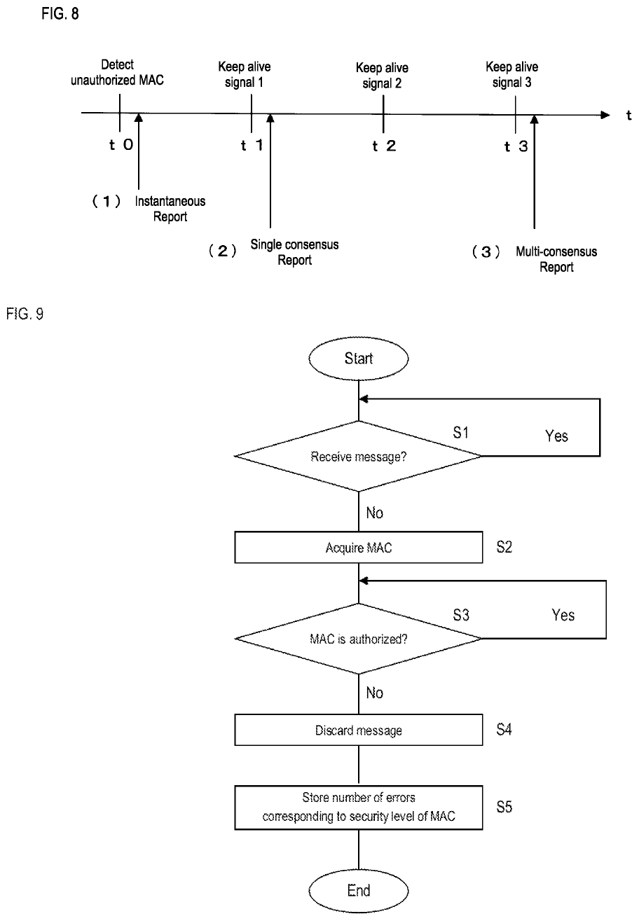

FIG. 8 is a schematic view illustrating a transmission timing of a report message by the DC 3A. This drawing is a timing chart assuming that the horizontal axis is a time t, and the timing when the DC 3A detects an unauthorized MAC is the time t0. It is also assumed that the timing when the DC 3A receives a keep alive signal reporting that an unauthorized MAC is detected from the first ECU is a time t1, the timing when the DC 3A receives a similar keep alive signal from the second ECU is a time t2, and the timing when the DC 3A receives a similar keep alive signal from the third ECU is a time t3. Assumed here is a network configuration in which more ECUs are connected to the DC 3A through the CAN bus, not the network configuration illustrated in FIGS. 3 and 4.

### Instantaneous Report

The DC 3A promptly transmits a report message after the MAC determination portion 31b determines that the MAC added to the message received by itself is an unauthorized MAC. In this case, the DC 3A transmits a report message based on the determination by the MAC determination portion 31b of itself. This is a method capable of transmitting a report message at the earliest timing.

### Single Consensus Report

The DC 3A waits for reception of a keep alive signal periodically transmitted by any ECU after the MAC determination portion 31b determines that the MAC added to the message received by itself is unauthorized. If receiving a keep alive signal including information that an unauthorized MAC is detected from any one of the ECUs, the DC 3A transmits a report message to the ECU required for a report. The ECU transmits a keep alive signal including information, for example, on the number of detections of an unauthorized MAC after transmission of the previous keep alive signal, etc. in association with the security level of the detected unauthorized MAC, the ID of the message to which this MAC is added or the like. If receiving a keep alive signal including information indicating that an unauthorized MAC is detected for the same security level as the security level for which the DC 3A of itself detects the unauthorized MAC, the DC 3A transmits a report message to the ECU to which the security level lower than this security level is set. After receiving the keep alive signal from the ECU, the DC 3A promptly transmits the report message. The DC 3A is configured to transmit a report message after determination by at least one of the ECUs, which can increase the reliability of a report message.

### Multiple Consensus Report

If receiving a keep alive signal including information indicating that an unauthorized MAC is detected from a predetermined number (majority, for example) of the ECUs out of multiple ECUs each having a security level higher than the security level of the MAC that is determined to be unauthorized, the DC 3A transmits a report message to the ECU to which a security level lower than this security level is set. In the exemplified example, after receiving keep alive signals from the three ECUs, the DC 3A promptly transmits a report message. The DC 3A is configured to transmit a report message after receiving the transmission of the keep alive signals from multiple ECUs, whereby it is further improve the reliability of a report message.

FIG. 9 is a flowchart showing the procedure of message reception processing performed by the ECU 4A according to the present embodiment. It is noted that the other ECUs 4B to 4I each perform similar processing. The transmission and reception processing portion 41c of the processing unit 41 of the ECU 4A according to the present embodiment determines whether or not a message is received from another one of the ECUs 4B, 4C or the DC 3A by the CAN communication unit 43 (step S1). If not receiving a message (S1: NO), the transmission and reception processing portion 41c waits until it receives a message. If receiving a message (S1: YES), the transmission and reception processing portion 41c acquires a MAC added to the received message (step S2).

The MAC determination portion 41b of the processing unit 41 determines whether or not the MAC acquired at step S2 is authorized (step S3). The MAC determination portion 41b here determines if the MAC is authorized depending on whether a MAC generated from the received message by using the encryption key stored in the key storage portion 42b matches the MAC acquired at step S2. If the MAC is authorized (S3: YES), the transmission and reception processing portion 41c ends the message reception processing.

If the MAC is not authorized (S3: NO), the transmission and reception processing portion 41c discards the received message (step S4). Furthermore, the ECU 4A stores the number of errors of the MAC for each security level in the storage unit 42, for example.

The transmission and reception processing portion 41c stores the number of errors corresponding to the security level of the MAC that is determined to be unauthorized at step S3 (step S5) and ends the message reception processing.

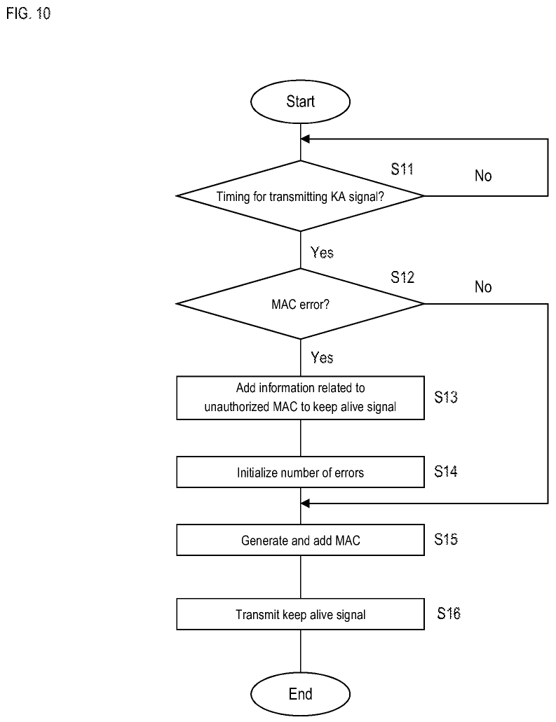

FIG. 10 is a flowchart showing the procedure of keep alive signal transmission processing performed by the ECU 4A according to the present embodiment. The report processing portion 41d of the processing unit 41 of the ECU 4A according to the present embodiment determines whether or not a timing for transmitting a keep alive (KA) signal to be periodically transmitted has been reached (step S11). If the timing for transmitting a keep alive signal has not been reached (S11: NO), the report processing portion 41d waits until the timing for transmitting a keep alive signal has been reached. If the timing for transmitting a keep alive signal has been reached (S11: YES), the report processing portion 41d determines the presence or absence of an error related to a MAC with reference to the number of errors for each security level stored in the storage unit 42 (step S12).

If an error has not occurred (S12: NO), that is, if any unauthorized MAC has not been detected since the transmission of the previous keep alive signal, the report processing portion 41d needs to transmit a normal keep alive signal not including the information related to an unauthorized MAC. Hence, the MAC generation portion 41a of the processing unit 41 generates a MAC related to a normal keep alive signal and adds the MAC to a keep alive signal (step S15). The report processing portion 41d transmits the keep alive signal to which the MAC is added by the CAN communication unit 43 (step S16) and ends the processing.

If an error has occurred (S12: YES), the report processing portion 41d adds the information related to detection of an unauthorized MAC such as the number of errors for each security level or the like stored in the storage unit 42, for example, to the keep alive signal (step S13). The report processing portion 41d initializes the number of errors for each security level stored in the storage unit 42 (step S14). Then, the MAC generation portion 41a generates a MAC for a keep alive signal to which the information on the unauthorized MAC is added and adds the MAC to a keep alive signal (step S15). The report processing portion 41d transmits the keep alive signal to which the MAC is added by the CAN communication unit 43 (step S16) and ends the processing.

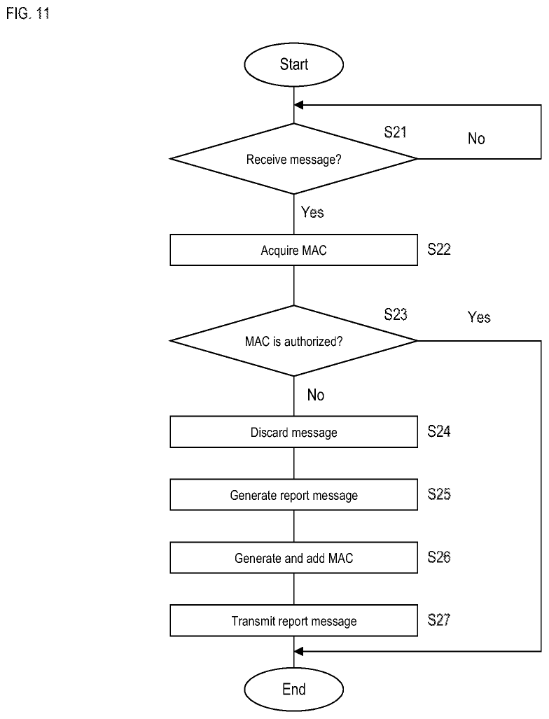

FIG. 11 is a flowchart showing the procedure of report message transmission processing performed by the DC 3A according to the present embodiment. The procedure corresponds to that for the above-mentioned (1) instantaneous report. The transmission and reception processing portion 31c of the processing unit 31 of the DC 3A according to the present embodiment determines whether or not a message from any one of the ECUs 4A to 4C is received by the CAN communication unit 33 (step S21). If not receiving a message (S21: NO), the transmission and reception processing portion 31c waits until it receives a message. If receiving a message (S21: YES), the transmission and reception processing portion 31c acquires a MAC added to the received message (step S22).

The MAC determination portion 31b of the processing unit 31 determines whether or not the MAC acquired at step S22 is authorized (step S23). The MAC determination portion 31b here determines an encryption key to be used for determining the authorization status of the MAC added to the received message with reference to the table shown in FIG. 6. The MAC determination portion 31b determines if the MAC is authorized depending on whether or not a MAC generated from the received message by using the encryption key stored in the key storage portion 32b matches the MAC acquired at step S22. If the MAC is authorized (S23: YES), the transmission and reception processing portion 41c ends the processing without transmitting a report message.

If the MAC is not authorized (S23: NO), the transmission and reception processing portion 41c discards the received message (step S24). Then, the report processing portion 31d of the processing unit 31 generates a report message reporting that an unauthorized MAC is detected (step S25). The report message includes information such as the security level of the MAC that is determined to be unauthorized, the ID of the message to which this MAC is added, etc. The MAC generation portion 31a of the processing unit 31 generates a MAC relative to the report message generated at step S25 and adds the MAC to the report message (step S26). Here, the MAC generation portion 31a reads out key information for report stored for each of the ECUs 4A to 4C to which a report message is to be transmitted from the key storage portion 32b and generates a different MAC for each of the ECUs 4A to 4C. Hence, if a report message is transmitted to the multiple ECUs 4A to 4C, multiple report messages to which different MACs are added are generated. The report processing portion 31d transmits the report message to which the MAC is added by the CAN communication unit 33 (step S27) and ends the processing.

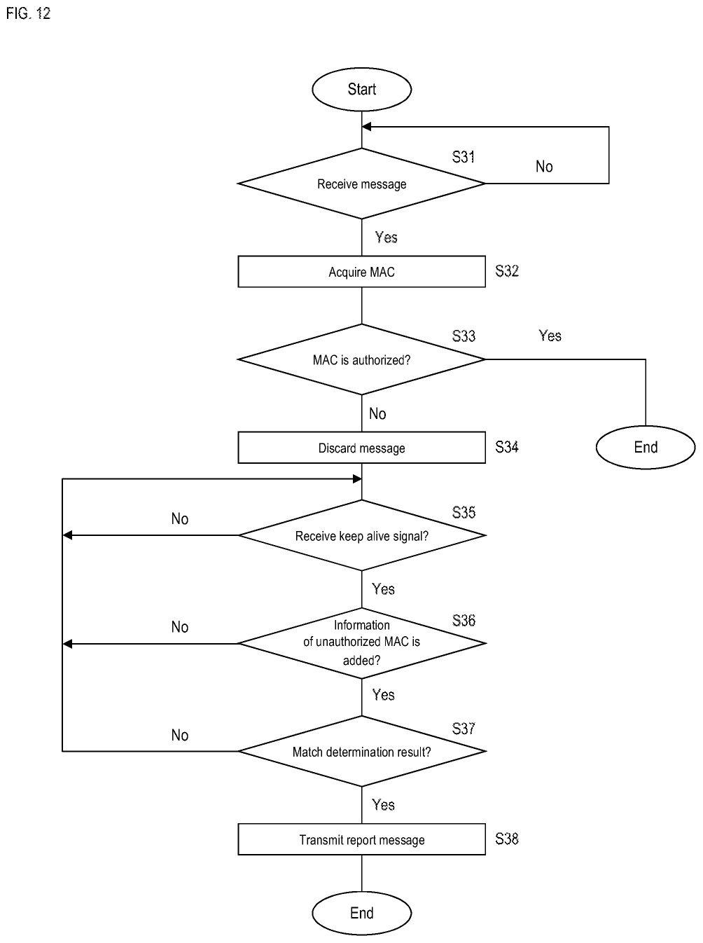

FIG. 12 is a flowchart showing the procedure of report message transmission processing performed by the DC 3A according to the present embodiment. The procedure corresponds to that for the above-mentioned (2) single consensus report. The transmission and reception processing portion 31c of the processing unit 31 of the DC 3A according to the present embodiment determines whether or not a message from any one of the ECUs 4A to 4C is received by the CAN communication unit 33 (step S31). If not receiving a message (S31: NO), the transmission and reception processing portion 31c waits until it receives a message. If receiving a message (S31: YES), the transmission and reception processing portion 31c acquires a MAC added to the received message (step S32). The MAC determination portion 31b of the processing unit 31 determines whether or not the MAC acquired at step S32 is authorized (step S33). If the MAC is authorized (S33: YES), the transmission and reception processing portion 31c ends the processing without transmitting a report message. If the MAC is not authorized (S33: NO), the transmission and reception processing portion 31c discards the received message (step S34).

Thereafter, the report processing portion 31d determines whether or not a keep alive signal transmitted from any one of the ECUs 4A to 4C is received by the CAN communication unit 33 (step S35). If receiving a keep alive signal (S35: YES), the report processing portion 31d confirms whether or not the MAC added to the received keep alive signal is authorized and then determines whether or not information on detection of an unauthorized MAC is added to the received keep alive signal (step S36). If the information on detection of an unauthorized MAC is added to the received keep alive signal (S36: YES), the report processing portion 31d determines whether or not the determination result of an unauthorized MAC indicated by the information added to the keep alive signal matches the determination result of an unauthorized MAC performed by the DC 3A itself at step S33 (step S37).

If not receiving a keep alive signal from any one of the ECUs 4A to 4C (S35: NO), if unauthorized MAC information is not added to the received keep alive signal (S36: NO), or if the determination result indicated by the information added to the keep alive signal does not match the determination result by the DC 3A itself (S37: NO), the report processing portion 31d returns the processing to step S35 and waits until it receives the keep alive signal with the information on the unauthorized MAC that matches the determination result by the DC 3A itself is received.

If determining that the determination result indicated by the information added to the keep alive signal matches the determination result by the DC 3A itself (S37: YES), the report processing portion 31d generates a report message reporting that an unauthorized MAC is detected, adds a MAC generated by using the key information for report to this report message, transmits the report message to which the MAC is added by the CAN communication unit 33 (step S38) and ends the processing.

It is noted that in the procedure of the report message transmission processing for the above-mentioned (3) multi-consensus report, the processing related to the keep alive signal shown at the above-described steps S35-37 may repeatedly be performed for each of the multiple ECUs 4A to 4C. The flowchart and the detailed description of this procedure are not be made here.

In the on-vehicle communication system according to the present embodiment with the configuration as described above, the DC 3A and the multiple ECUs 4A to 4C are connected to the common CAN bus. The multiple ECUs 4A to 4C are classified by multiple security levels (levels 1, 2), and for each of the security levels, a common key (s) (key a, b) is defined. Each of the ECUs 4A to 4C stores one or multiple keys a, b according to the security level of itself in the key storage portion 42b, transmits a message to which a MAC generated by using the stored keys a, b is added and determines whether or not a MAC added to a received message is authorized. Since messages with MACs generated by using the different keys a, b are transmitted and received on the common CAN bus, each of the ECUs 4A to 4C can determine the authorization status of a message with the MAC generated by the same key a, b as the key held by itself but cannot determine the authorization status of a message with the MAC generated by a key a, b not held by itself.

The DC 3A stores keys a, b for the respective security levels in the key storage portion 32b and performs determination by using the key a, b corresponding to the MAC added to the received message. The DC 3A can determine whether or not the MAC added to the message is authorized for all the messages transmitted and received through the common CAN bus. If receiving a message to which an unauthorized MAC is added, the DC 3A transmits a report message to the ECUs 4A to 4C not having the keys a, b used for determination of this MAC.

Thus, each of the ECUs 4A to 4C can perform determination on a message that allows determination of the authorization status of the MAC by using the key a, b stored by itself and can perform determination by receiving a report message from the DC 3A for a message that does not allow determination of the authorization status by itself, to thereby determine that an unauthorized message is transmitted to the common CAN bus. This allows the coexistence of the ECUs 4A to 4C with different security levels on the common CAN bus.

In the on-vehicle communication system according to the present embodiment, multiple MACs can be added to a message.

Each of the ECUs 4A to 4C stores a key a, b specified for a security level of itself and a key a, b specified for a security level lower than the security level of itself. Each of the ECUs 4A to 4C storing multiple keys a and b generates multiple MACs by using the multiple keys a and b and transmits a message to which the generated multiple MACs are added. This allows the ECUs 4A to 4C to transmit a message not only to the ECUs 4A to 4C having the same security level as that of the ECU of its own but also to the ECUs 4A to 4C having a security level lower than this security level.

In the on-vehicle communication system according to the present embodiment, each of the ECUs 4A to 4C having received a message to which multiple MACs are added determines the authorization status of at least one MAC for which determination of the authorization status is allowed by using the key a, b stored by itself. Thus, the ECU 4A to 4C can determine whether or not a message is authorized and receive the message even if the message is transmitted from another one of the ECUs 4A to 4C with the security level higher than that of the ECU itself, if the message is a message with a MAC for which the determination of the authorization status is allowed by using the key a, b stored by itself. Thus, the multiple ECUs 4A to 4C connected to the common CAN bus can broadcast messages to multiple ECUs 4A to 4C including the ECUs 4A to 4C with different security levels.

In the on-vehicle communication system according to the present embodiment, if determining that the MAC added to the received message is not authorized, each of the ECUs 4A to 4C makes a report to the DC 3A by using a keep alive signal. The DC 3A transmits a report message indicating that an unauthorized MAC is detected to the ECUs 4a to 4C if determining by itself that the MAC added to the message is not authorized and receiving a report from the ECUs 4A-4C. This makes it possible to enhance the reliability of the report message transmitted from the DC 3A to the ECUs 4A to 4C. This can prevent normal transmission and reception of messages from being hindered by a report made from the ECUs 4A to 4C to the DC 3A. The DC 3A can detect an abnormality related to communication based on the information included in a keep alive signal and can also detect any abnormality if not receiving a keep alive signal.

In the present embodiment, in order to generate and determine a MAC to be added to a report message sent from the DC 3A to the ECUs 4A to 4C, the ECUs 4A to 4C is configured to store, though not limited to, the keys α, β, γ respectively. The DC 3A and the ECUs 4A to 4C need not be provided with special encryption keys for transmitting and receiving report messages. Furthermore, the report message may be broadcasted to all the ECUs 4A to 4C instead of being individually transmitted to each of the ECUs 4A to 4C.

The device configuration, the network configuration and system configuration in the illustrated on-vehicle communication system are mere examples and not limited thereto. The classification of the security levels and the assignment of the common keys illustrated in the table shown in FIG. 6 are mere examples and not limited thereto.

### Embodiment 2

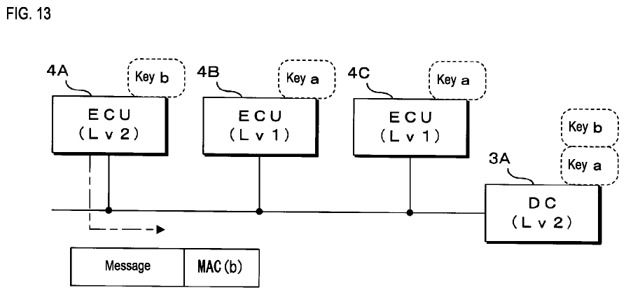

FIG. 13 is a schematic view illustrating one example of transmission and reception of messages performed between a DC 3A and ECUs 4A to 4C according to Embodiment 2. In the on-vehicle communication system according to Embodiment 2, each of the ECUs 4A to 4C stores only one key a, b corresponding to the security level of itself and does not store a key a, b with a security level lower than the security level of itself. Each of the ECUs 4A to 4C generates a MAC using the one key a, b stored by itself and transmits a message to which the one MAC is added. In the illustrated example, the ECU 4A storing the key b corresponding to the security level 2 generates a MAC (b) by using the key b and transmits a message to which the MAC (b) is added. The message cannot be received by the ECUs 4B and 4C that do not store the key b. The DC 3A stores the keys a, b corresponding to all the security levels and can determine whether or not the message is authorized by using the key b corresponding to the MAC (b) added to the received message.

In the on-vehicle communication system according to Embodiment 2, one of the ECUs 4A to 4C cannot directly transmit and receive messages to and from another one of the ECUs 4A to 4C not having the same key a, b as that held by this ECU itself. Thereupon, the DC 3A according to Embodiment 2 performs processing of relaying a message between the different security levels. In the illustrated example, the DC 3A having received a message to which the MAC (b) is added from the ECU 4A determines that this message is authorized by using the key b stored by itself, then generates a MAC (a) by using the key a stored by itself, adds this MAC (a) to this message and transmits the message to which the MAC (a) is added to the ECUs 4B and 4C. The ECUs 4B and 4C each determine whether or not the MAC (a) added to the message sent from the DC 3A is authorized by using the key a stored by itself and thus can receive the message.

The DC 3A transmits a report message if determining that the MAC added to the received message is unauthorized. In the Embodiment 1, the DC 3A transmits a report message to the ECUs 4A to 4C with a security level lower than the security level of the unauthorized MAC. In contrast thereto, the DC 3A according to Embodiment 2 transmits a report message to the ECUs 4A to 4C with a security level different from that of the unauthorized MAC. In the illustrated example, if determining that the MAC (a) added to the message that is transmitted from the ECU 4B is unauthorized, for example, the DC 3A transmits a report message to the ECU 4A with a security level 2 different from the security level 1 of the MAC (a), that is, to the ECU 4A not having a key a required for determining the MAC (a).

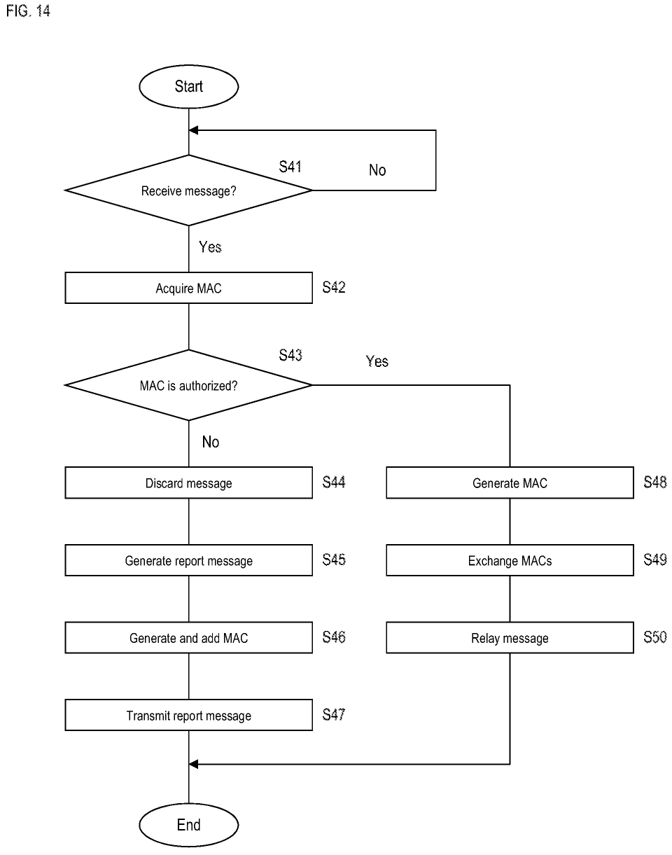

FIG. 14 is a flowchart showing a processing procedure performed by the DC 3A according to Embodiment 2. The transmission and reception processing portion 31c of the processing unit 31 of the DC 3A according to Embodiment 2 determines whether or not a message from one of the ECUs 4A to 4C is received by the CAN communication unit 33 (step S41). If not receiving a message (S41: NO), the transmission and reception processing portion 31c waits until it receives a message. If receiving a message (S41: YES), the transmission and reception processing portion 31c acquires a MAC added to the received message (step S42).

The MAC determination portion 31b of the processing unit 31 determines whether or not the MAC acquired at step S42 is authorized (step S43). If the MAC is not authorized (S43: NO), the transmission and reception processing portion 41c discards the received message (step S44). Then, the report processing portion 31d of the processing unit 31 generates a report message reporting that an unauthorized MAC is detected (step S45). The MAC generation portion 31a of the processing unit 31 generates a MAC for the report message generated at step S45 and adds the MAC to the report message (step S46). The report processing portion 31d transmits the report message to which the MAC is added to the CAN communication unit 33 (step S47) and ends the processing.

If the MAC is authorized (S43: YES), the transmission and reception processing portion 41c reads from the key storage portion 32b an encryption key with a security level different from the security level of the MAC that is determined to be authorized and generates a MAC with the different security level for the received message (step S48). The transmission and reception processing portion 41c deletes the MAC added to the received message and adds the MAC generated at step S48 to the message to thereby exchange the MACs of the message (step S49). The transmission and reception processing portion 41c transmits the message for which the MAC has been exchanged by the CAN communication unit 33 to thereby relay a message between the devices with the different security levels (step S50) and ends the processing.

In the on-vehicle communication system according to Embodiment 2 as described above, one MAC is added to a message.

Each of ECUs 4A-4C stores one key a, b specified for the security level of itself, generates one MAC using the key a, b and transmits a message to which the generated one MAC is added. This makes it possible to simplify the configuration of each of the ECUs 4A to 4C. This also makes it easy to separately handle the ECUs 4A to 4C with different security levels.

Meanwhile, the DC 3A according to Embodiment 2 receives a message transmitted from one of the ECUs 4A to 4C and determines whether or not the MAC added to the message is authorized. Then, the DC 3A adds a MAC generated by using a key a, b different from the key a, b used for the determination to the message that is determined to be authorized and transmits the message with the new MAC to the CAN bus. This allows the DC 3A to relay transmission and reception of messages between the ECUs 4a to 4C having different security levels. Each of the ECUs 4A to 4C can transmit a message to all the ECUs 4A to 4C connected to the CAN bus via the DC 3A.

The other configurations of the on-vehicle communication system according to Embodiment 2 are similar to those of the on-vehicle communication system according to Embodiment 1, and thus similar components are denoted by the same reference codes and detailed description thereof is not made here.

### Embodiment 3

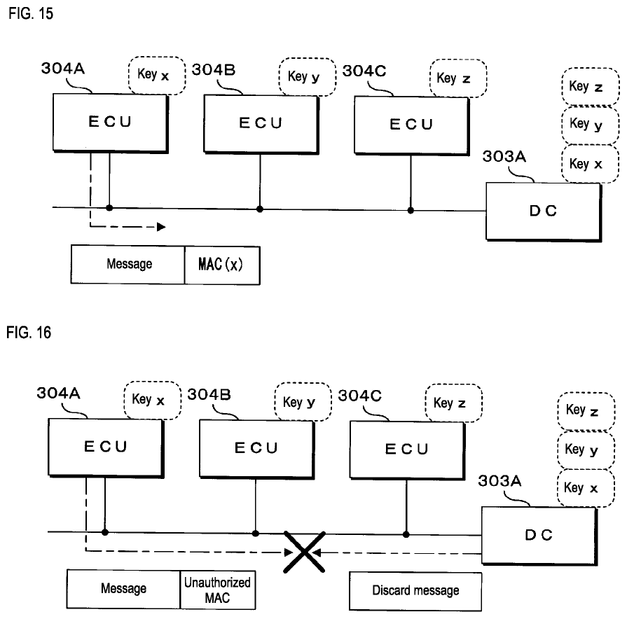

FIG. 15 is a schematic view illustrating one example of transmission and reception of messages performed between a DC 303A and ECUs 304A to 304C according to Embodiment 3. In the on-vehicle communication system according to Embodiment 3, the multiple ECUs 304A to 304C connected to a common CAN bus respectively store different keys x to z. The DC 303A connected to this CAN bus stores keys x to z for the ECUs 304A to 304C. Each of the ECUs 304A to 304C generates a MAC using the key x to z stored by itself and each transmit a message to which the one MAC is added. In the illustrated example, the ECU 304A having stored the key x generates a MAC (x) by using the key x and transmits a message to which the MAC (x) is added.

In the on-vehicle communication system according to Embodiment 3, each of the ECUs 304A to 304C does not determine whether or not the MAC added to a received message is authorized. Thus, the message with the MAC (x) transmitted by the ECU 403A can also be received by the ECUs 304B and 304C that do not store the key x. Each of the ECUs 304B and 304C uses the message for its own processing without performing determination of whether or not the MAC (x) added to the received message is authorized.

In the on-vehicle communication system according to Embodiment 3, determination of the authorization status of the MAC added to the message transmitted by each of the ECUs 403A to 403C is performed by the DC 303A. The message transmitted and received in the on-vehicle communication system according to Embodiment 3 can employ the configuration of a data frame according to the CAN communication protocol. The CAN data frame is formed of multiple fields including, for example, a start of frame, an arbitration field, a control field, a data field, a CRC field, an ACK field, an end of frame, etc. The MAC is stored in a part of the data field, for example.

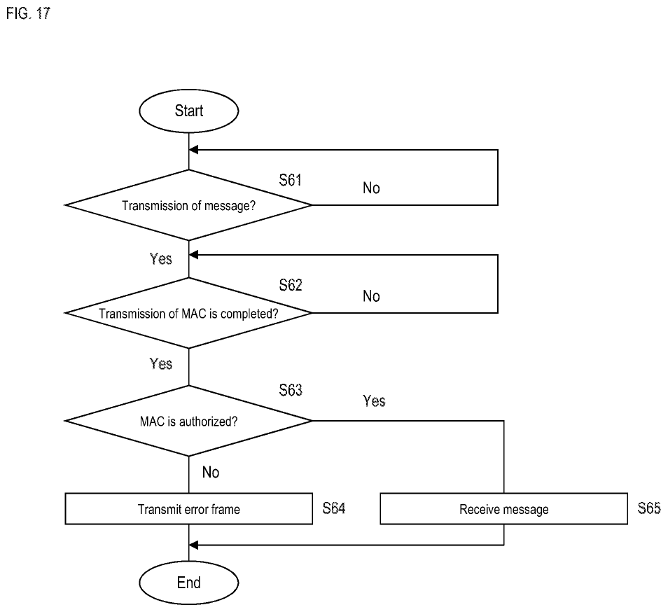

FIG. 16 is a schematic view illustrating discard of a message by the DC 303 A according to Embodiment 3. The DC 303A according to Embodiment 3 monitors the transmission of a message sent to the CAN bus from any one of the ECUs 304A to 304C. After start of transmission of a message, the DC 303A determines whether or not the MAC included in the data field is authorized at a time when transmission of the data field is completed. If determining that the MAC is unauthorized, the DC 303A hinders the transmission of this message by transmitting an error frame defined according to the CAN communication protocol before completion of this transmission of this message. The transmission of the message to which the unauthorized MAC is added is interrupted, and the ECUs 304A to 304C discard the message.

The processing such as determination of a MAC and transmission of an error frame performed by the DC 303A according to Embodiment 3 needs to be conducted before completion of the transmission of the message. Thus, these processing are preferably performed by the CAN communication unit 33, not by the processing unit 31 of the DC 303A.

In addition, the method of causing each of the ECUs 304A to 304C to discard a message by the DC 303A is not limited to transmission of an error frame. For example, the DC 303A may be configured to cause each of the ECUs 304A to 304C to discard a message by outputting a signal for inverting data of a predetermined bit included in the message to the CAN bus. The DC 303A may cause the ECUs 304A to 304C to discard a message by altering the message such that it cannot be identified as an authorized message by the ECUs 304A to 304C before completion of the transmission of the message.

FIG. 17 is a flowchart showing the procedure of processing performed by the DC 303A according to Embodiment 3. The DC 303A according to Embodiment 3 determines the presence or absence of transmission of a message from any one of the ECUs 304A to 304C connected to the CAN bus (step S61). If message transmission is absent (S61: NO), the DC 303A waits for the message to be sent. If message transmission is present (S61: YES), the DC 303A determines whether or not transmission of the MAC included in the message is completed (step S62). If the transmission of the MAC is not completed (S62: NO), the DC 303A waits until the transmission of the MAC is completed.

If the transmission of the MAC is completed (S62: YES), the DC 303A determines whether or not the MAC is authorized for the message that is being transmitted (step S63). If determining that the MAC is not authorized (S63: NO), the DC 303A transmits an error frame to the CAN bus (step S64) before completion of the transmission of the message and ends this processing. If determining that this MAC is authorized (S63: YES), the DC 303A receives this message (step S65) and ends the processing.

In the on-vehicle communication system according to Embodiment 3 as described above, the multiple ECUs 304A to 304C connected to the common CAN bus are specified with the keys x, y, z, respectively. Each of the ECUs 304A to 304C stores the key x, y, z specified for itself and transmits a messages to which a MAC generated by using this key x, y, z is added. The DC 303A stores respective keys x, y, z specified for the multiple ECUs 304A to 304C that are connected to the common CAN bus, and determines whether or not the MAC added to a message transmitted to the CAN bus is authorized by using any one of the stored keys x, y, z. Thus, the multiple ECUs 304A to 304C connected to the common CAN bus can be separated by security levels and can individually transmit and receive messages to and from the DC 303A, resulting in enhanced security.

In the on-vehicle communication system according to Embodiment 3, each of the ECUs 304A to 304C determines whether or not the MAC added to a received message is authorized by using the x, y, z held by itself. If determining that the MAC added to a received message is authorized, the DC 303A generates a MAC using a key x, y, z different from the key x, y, z used for the determination and transmits a message to which the generated MAC is added to the CAN bus. This allows the DC 303A to relay a message transmitted and received between the ECUs 304A to 304C. One of the ECUs 304A to 304C can transmit and receive a message with another one of the ECUs 304A to 304C via the DC 303A.

In the on-vehicle communication system according to Embodiment 3, the DC 303A determines whether or not the MAC added to this message is authorized before completion of the transmission of a message by the ECUs 304A to 304C. If determining that the MAC is not authorized, the DC 303A transmits an error frame to the ECUs 304A to 304C before the completion of the transmission of this message to thereby cause the ECUs 304A to 304C to discard this message. Thus, each of the ECUs 304A to 304C needs not to determine whether or not the MAC added to a message is authorized and can receive a message that is not caused to discard by the DC 303A without performing the determination of the authorization status and can use the message for the processing thereafter.

In Embodiment 3, the DC 303A is configured to determine the authorization status of a MAC to cause the ECUs 304A to 304C to discard an unauthorized message without each of the ECUs 304A to 304C determining the authorization status of the MAC added to a message, though the configuration is not limited to the above-described one. Similarly to Embodiments 1 and 2, each of the ECUs 304A to 304C and the DC 303A may determine the authorization status of a MAC, and the DC 303A may transmit a report message to the ECUs 304A to 304C if detecting an unauthorized MAC. In contrast thereto, in the on-vehicle communication system according to Embodiments 1 and 2 as well, the DC 3A may cause the ECUs 304A to 304C to discard an unauthorized message not by transmitting a report message, but by transmitting an error frame thereto before completion of the transmission of the message.

The other configurations of the on-vehicle communication system according to Embodiment 3 are similar to those of the on-vehicle communication system according to Embodiment 1, and thus similar components are denoted by the same reference codes and detailed description is not made here.

Each device in the on-vehicle system is provided with a computer composed of a microprocessor, a ROM, RAM, etc. The computational processing unit in the microprocessor or the like may read out a computer program including a sequence diagram or a part or all of the steps of the flowchart as shown in FIGS. 9 to 12, FIG. 14 and FIG. 17 from the storage unit such as the ROM, the RAM, etc. and execute the program. The computer programs for these multiple devices can be installed from an external server device or the like. The computer programs for these multiple devices are circulated while being stored in a recording medium such as a CD-ROM, a DVD-ROM, a semiconductor memory or the like.

It is to be understood that the embodiments disclosed here is illustrative in all respects and not restrictive. The scope of the present invention is defined by the appended claims, and all changes that fall within the meanings and the bounds of the claims, or equivalence of such meanings and bounds are intended to be embraced by the claims.

1. An on-vehicle communication system comprising a plurality of on-vehicle communication devices connected to a common communication line and an on-vehicle communication control device connected to the common communication line and performing control related to communication between the plurality of on-vehicle communication devices,
wherein the plurality of on-vehicle communication devices are classified by a plurality of security levels, and a common key is specified for each of the security levels,
an on-vehicle communication device of the on-vehicle communication devices includes
a first storage unit that stores a common key according to a security level of the on-vehicle communication device,
a first authentication code generation unit that generates an authentication code to be added to a message to be transmitted by using a common key stored in the first storage unit, and
a first authentication code determination unit that determines whether or not an authentication code added to a received message is authorized by using a common key stored in the first storage unit, wherein
the on-vehicle communication control device includes
a second storage unit that stores a common key for each of the security levels,
a second authentication code determination unit that determines whether or not an authentication code added to a received message is authorized by using a corresponding common key stored in the second storage unit, and
a second report unit that, if the second authentication code determination unit determines that an authentication code added to a received message is not authorized, makes a report to another one of the on-vehicle communication devices that does not store a common key used for the determination by the second authentication code determination unit.

2. The on-vehicle communication system according to claim 1, wherein
a plurality of authentication codes are able to be added to a message,
the on-vehicle communication device stores a common key specified for a security level of the on-vehicle communication device and a common key specified for a security level lower than the security level in the first storage unit, and
the first authentication code generation unit generates one or a plurality of authentication codes to be added to a message to be transmitted by using one or a plurality of common keys stored in the first storage unit.

3. The on-vehicle communication system according to claim 2, wherein the first authentication code determination unit of the on-vehicle communication device performs determination on an authentication code for which determination of an authorization status is allowed by using the one or plurality of common keys stored in the first storage unit of the on-vehicle communication device out of authentication codes added to a received message.

4. The on-vehicle communication system according to claim 1, wherein
one authentication code is added to a message,
the on-vehicle communication device stores one common key specified for a security level of the on-vehicle communication device in the first storage unit, and
the first authentication code generation unit generates one authentication code to be added to another message to be transmitted by using the one common key stored in the first storage unit.

5. The on-vehicle communication system according to claim 4, wherein
the on-vehicle communication control device comprises
a second authentication code generation unit that, if the second authentication code determination unit determines that an authentication code added to a received message is authorized, generates another authentication code using a common key different from a common key used for the determination of the authentication code, and
a relay unit that relays a message transmitted and received between the on-vehicle communication devices with different security levels by transmitting the received message to which the different authentication code generated by the second authentication code generation unit is added.

6. The on-vehicle communication system according claim 1, wherein
the on-vehicle communication device includes a first report unit that makes a report to the on-vehicle communication control device if the first authentication code determination unit determines that an authentication code added to a received message is not authorized, and
the second report unit of the on-vehicle communication control device makes a report if the second authentication code determination unit determines that an authentication code added to a received message is not authorized and a report is received from the first report unit of the on-vehicle communication device.

7. The on-vehicle communication system according to claim 6, wherein
the on-vehicle communication device periodically transmits a keep alive signal to the common communication line, and
the first report unit makes a report to the on-vehicle communication control device by the keep alive signal.

8. An on-vehicle communication system comprising a plurality of on-vehicle communication devices connected to a common communication line and an on-vehicle communication control device connected to the common communication line and performing control related to communication between the plurality of on-vehicle communication devices,
wherein an encryption key is specified for each of the on-vehicle communication devices,
an on-vehicle communication device of the on-vehicle communication devices includes
a first storage unit that stores an encryption key specified for the on-vehicle communication device, and
a first authentication code generation unit that generates an authentication code to be added to a message to be transmitted by using an encryption key stored in the first storage unit, wherein
the on-vehicle communication control device includes
a second storage unit that stores an encryption key for each of the on-vehicle communication devices and
a second authentication code determination unit that determines whether or not an authentication code added to a received message is authorized by using a corresponding encryption key stored in the second storage unit.

9. The on-vehicle communication system according to claim 8, wherein
the on-vehicle communication device includes a first authentication code determination unit that determines whether or not an authentication code added to a received message is authorized by using an encryption key stored in the first storage unit, and
the on-vehicle communication control device includes
a second authentication code generation unit that, if the second authentication code determination unit determines that an authentication code added to a received message is authorized, generates a different authentication code by using an encryption key different from an encryption key used for the determination of this authentication code and
a relay unit that relays a message transmitted and received between the on-vehicle communication devices with different security levels by transmitting the received message to which the different authentication code generated by the second authentication code generation unit is added.

10. The on-vehicle communication system according to claim 8, wherein
the on-vehicle communication control device performs determination by the second authentication code determination unit before completion of transmission of a message and includes a discard processing unit that performs processing of causing the on-vehicle communication device to discard the message before completion of transmission of the message if the second authentication code determination unit determines that an authentication code added to the message is not authorized.

11. An on-vehicle communication control device connected to a common communication line to which a plurality of on-vehicle communication devices are connected and performing control related to communication between the plurality of on-vehicle communication devices,
wherein the plurality of on-vehicle communication devices are classified by a plurality of security levels, and a common key is specified for each of the security levels,
the on-vehicle communication control device comprising:
a storage unit that stores a common key for each of the security levels;
an authentication code determination unit that determines whether or not an authentication code added to a received message is authorized by using a corresponding common key stored in the storage unit; and
a report unit that, if the authentication code determination unit determines that an authentication code added to a received message is not authorized, makes a report to another one of the on-vehicle communication devices that does not store a common key used for the determination by the authentication code determination unit.

12. The on-vehicle communication control device according to claim 11, further comprising:
an authentication code generation unit that, if the authentication code determination unit determines that an authentication code added to a received message is authorized, generates a different authentication code by using a common key different from a common key used for the determination of the authentication code; and
a relay unit that relays a message transmitted and received between the on-vehicle communication devices with different security levels by transmitting the received message to which the different authentication code generated by the authentication code generation unit is added.

13. The on-vehicle communication control device according to claim 11, wherein
the on-vehicle communication device makes a report if it is determined that an authentication code added to a received message is not authorized, and
the report unit makes a report if the authentication code determination unit determines that an authentication code added to a received message is not authorized and a report from the on-vehicle communication device is received.

14. An on-vehicle communication device connected to a common communication line, wherein a plurality of on-vehicle communication devices connected to the common communication line are classified by a plurality of security levels, and a common key is specified for each of the security levels,
the on-vehicle communication device comprising:
a storage unit that stores a common key according to a security level of the on-vehicle communication device;
an authentication code generation unit that generates an authentication code to be added to a message to be transmitted by using a common key stored in the storage unit;
an authentication code determination unit that determines whether or not an authentication code added to a received message is authorized by using a common key stored in the storage unit; and
a report unit that makes a report to another one of the on-vehicle communication devices connected to the common communication line if the authentication code determination unit determines that an authentication code added to a received message is not authorized.

15. The on-vehicle communication device according to claim 14, wherein the report unit makes a report by a keep alive signal periodically transmitted to the common communication line.

16. The on-vehicle communication device according to claim 14, wherein:
a plurality of authentication codes are able to be added to a message,
the storage unit stores a common key specified for a security level of the on-vehicle communication device and a common key specified for a security level lower than the security level, and
the authentication code generation unit generates one or plurality of authentication codes to be added to a message to be transmitted by using one or plurality of common keys stored in the storage unit.

17. The on-vehicle communication device according to claim 16, wherein the authentication code determination unit performs determination on an authentication code for which determination of an authorization status is allowed by using the one or plurality of common keys stored in the storage unit of the on-vehicle communication device out of authentication codes added to a received message.

18. The on-vehicle communication device according to claim 14, wherein one authentication code is added to a message,
the storage unit stores one common key specified for a security level of the on-vehicle communication device, and
the authentication code generation unit generates one authentication code to be added to another message to be transmitted by using the one common key stored in the storage unit.

19. A communication control method for, by an on-vehicle communication control device that is connected to a common communication line to which a plurality of on-vehicle communication devices are connected, performing control related to communication between the plurality of on-vehicle communication devices,
wherein the plurality of on-vehicle communication devices are classified by a plurality of security levels, and a common key is specified for each of the security levels,
the communication control method comprising:
storing a common key according to each of the security levels in a storage unit;
determining whether or not an authentication code added to a received message is authorized by using a corresponding common key stored in the storage unit; and
making, if an authentication code added to a received message is not authorized, a report to another one of the on-vehicle communication devices that does not store a common key used for this determination.

20. A communication method for performing processing related to communication between a plurality of on-vehicle communication devices connected to a common communication line,
wherein the plurality of on-vehicle communication devices connected to the common communication line are classified by a plurality of security levels, and a common key is specified for each of the security levels,
the communication method comprising:
storing a common key according to a security level of an on-vehicle communication device in a storage unit;
generating an authentication code to be added to a message to be transmitted by using a common key stored in the storage unit;
determining whether or not an authentication code added to a received message is authorized by using a common key stored in the storage unit; and
making a report to another one of the on-vehicle communication devices connected to the common communication line if it is determined that an authentication code added to a received message is not authorized.
